(19) United States
(12) Patent Application Publication
(10) Pub. No.: US 2004/0042619 A1
(43) Pub. Date: Mar. 4, 2004

(54) Method and apparatus for signal scrambling/descrambling, and method of speech secrecy based on the same

(76) Inventor: Akio Yamaguchi, Tokyo (JP)

Correspondence Address: HAYNES AND BOONE, LLP, 901 MAIN STREET, SUITE 3100, DALLAS, TX, 75202, US

(21) Appl. No.: 10/234,009

(22) Filed: Sep. 3, 2002

(51) Int. Cl. H04K 1/02

(52) U.S. Cl. 380/252

(57) ABSTRACT

An analog signal scrambling/descrambling method is intended to have the higher encryption durability and applicability to the international telephone and shortwave radio communication which rely on low-quality transmission links. The scrambling and descrambling processes use FIR filters for implementing the linear convolution of input signals, delay means, constant number generation means, adders and multipliers. The constant number generation means produce outputs that are non-zero and smaller than 1 in absolute value, one FIR filter used for one of the scrambling process and descrambling process has a filter factor h which is generated based on the discrete Fourier transform, and another FIR filter used for another process has a filter factor that is the time-reverse version of the filter factor h.

### BACKGROUND OF THE INVENTION

1. Field of the Invention

The present invention relates to the encryption of analog signal, and particularly to the technology of voice signal processing which deals with speech secrecy devices and methods and signal scrambling schemes and circuits.

2. Description of the Prior Art

Conventional techniques of analog signal encryption, particularly schemes of voice signal scrambling, are mainly as follows.

(1) Spectrum reverse process

(2) Frequency band split and swap process

(3) Waveform split, reverse and swap process on the time axis

(4) Multiplication of a binary pseudo random number string

Among these schemes, the spectrum reversing process of item (1) is spectrum high/low reversion for the input signal.

The frequency band split and swap process of item (2) is to split the input signal frequencies into several bands with band-pass filters (filter bank) and swap the bands on the frequency axis.

The waveform split, reverse and swap process of item (3) is to split the input signal waveform into segments of a constant length and reverse and swap the waveform segments on the time axis.

The multiplication of binary pseudo random number strings of item (4) is accomplished by using analog multipliers or analog switches, or simply multiplying a binary pseudo random number string of 1 and −1 to a A/D converted signal.

However, these conventional analog signal encryption techniques have the following drawbacks.

The spectrum reversing process of item (1), which can be accomplished by a simple circuit arrangement, is extremely low in encryption durability and the encryption is broken easily. Devices for decrypting signals which have been encrypted based on the spectrum reversing process and receivers which incorporate the decryption devices are available in the market, and therefore this encryption process has virtually no effect. An imposed version of this process which varies the upper-limit frequency of spectrum reversion band with time also has a drawback of the need of transmission of a sync signal with the scrambled voice signal in order to synchronize the operations of the sending side and receiving side.

The Frequency band split and swap process of item (2) is deficient in encryption durability and the encryption is broken relatively easily. An imposed version of this process which varies the order of band swapping with time has the same drawback of the need of transmission of a sync signal for the synchronized operations.

The time-wise waveform split, reverse and swap process of item (3) is also deficient in encryption durability. This process obliges the decryption side, for the sake of error-free decryption process, to operate with a clock signal and sync signal which are completely synchronous with the counterparts of the encryption side. Namely, it has a drawback of the need of transmission of a clock signal and sync signal with the encrypted signal or the need of provision of very accurate in-phase clock signals on both sides of encryption and decryption.

The binary pseudo random number string multiplication of item (4) has the same drawback of the need of clock signals which are completely synchronous on both sides of encryption and decryption.

### SUMMARY OF THE INVENTION

An object of the present invention to accomplish a scheme of analog signal encryption which has adequate encryption durability, does not necessitate the clock signal synchronization, and is applicable to the international telephone communication and shortwave radio communication which rely on low-quality transmission links.

In order to achieve the above objective, the inventive signal scrambling apparatus comprises a signal input terminal which introduces an analog signal, an A/D converter which converts the analog signal on the signal input terminal into a digital signal, an FIR filter which implements the scrambling for the digitized signal, a D/A converter which converts the scrambled digital signal into an analog signal, a signal output terminal which is connected to the D/A converter to release the scrambled analog signal, a delay means which delays the output signal of the FIR filter, a constant number generation means which provides a constant number for the output of the delay means, a multiplier which multiplies the output of the constant number generation means to the output of the delay means, and an adder which adds the output of the multiplier to the output of the A/D converter.

In this scrambling apparatus, the delay means is connected to the output terminal of the FIR filter to delay the output thereof, and the multiplier multiplies output k of the constant number generation means to the output of the delay means. The multiplier has its output added to the input signal by the adder, with the result being put to the FIR filter. Accordingly, a feedback circuit is formed, in which a certain signal delaying process and signal multiplying process take place for the output signal of the FIR filter.

The above-mentioned arrangement of this invention enables the signal scrambling at high encryption durability, making the breaking of encryption difficult and gaining the effect of encryption.

These and other objects and advantages of the present invention will become apparent from the following description taken in conjunction with the accompanying drawings.

### BRIEF DESCRIPTION OF THE DRAWINGS

FIG. 1 is a block diagram showing the arrangement of the scrambling circuit based on a first embodiment of this invention;

FIG. 2 is a block diagram showing the arrangement of the descrambling circuit based on the first embodiment which is used in pairs with the scrambling circuit shown in FIG. 1;

FIG. 3 is a waveform diagram of the first embodiment showing a sweep signal h[k] which is generated in accordance with formulas (1) and (2) with the setup of parameter α=2 and period L=512;

FIG. 4 is a waveform diagram of the first embodiment showing the result of circular shift by 128 samples to the left for the signal h[k] shown in FIG. 3;

FIG. 5 is a waveform diagram of the first embodiment showing the result of time reversion for the signal shown in FIG. 4;

FIG. 6 is a waveform diagram of the first embodiment showing the result of linear convolution of the signals shown in FIG. 4 and FIG. 5;

FIG. 7 is an amplitude spectral graph of the first embodiment showing the result of discrete Fourier transform for the waveform shown in FIG. 6;

FIG. 8 is a waveform diagram of the first embodiment showing another sweep signal h[k] which is generated in accordance with formulas (1) and (2) with the setup of parameter α=1 and period L=512;

FIG. 9 is a waveform diagram of the first embodiment showing a window function w[n] which is generated in accordance with formula (7) with the setup of period L=512 and parameter P=16;

FIG. 10 is a waveform diagram of the first embodiment showing the result of multiplication of the window function of FIG. 9 to the sweep signal of FIG. 8;

FIG. 11 is a waveform diagram of the first embodiment showing the result of linear convolution of the signal of FIG. 10 and the time-reverse version thereof;

FIG. 12 is an amplitude spectral graph of the first embodiment showing the result of discrete Fourier transform for the waveform shown in FIG. 11;

FIG. 13 is a waveform diagram of the first embodiment showing another sweep signal h[k] which is generated in accordance with formulas (1) and (2) with the setup of parameter α=0.5 and period L=512;

FIG. 14 is a waveform diagram of the first embodiment showing the result of multiplication of the window function of FIG. 9 to the sweep signal of FIG. 13;

FIG. 15 is a waveform diagram of the first embodiment showing the result of linear convolution of the signal of FIG. 14 and the time-reverse version thereof;

FIG. 16 is an amplitude spectral graph of the first embodiment showing the result of discrete Fourier transform for the waveform shown in FIG. 15;

FIG. 17 is a waveform diagram of the first embodiment pertinent to the implementation of scrambling process and descrambling process at different sampling frequencies, showing the impulse response of the signal shown in FIG. 4 after it has undergone the D/A conversion at a sampling frequency of 10 kHz and subsequently undergone the A/D conversion at another sampling frequency of 10.1 kHz and the linear convolution with the signal shown in FIG. 5;

FIG. 18 is an amplitude spectral graph of the first embodiment showing the result of discrete Fourier transform for the impulse response shown in FIG. 17;

FIG. 19 is a waveform diagram of the first embodiment showing a voice signal of male person which is introduced by being sampled at a sampling frequency of 6 kHz;

FIG. 20 is a diagram of the first embodiment showing the spectrograph of the voice signal waveform of FIG. 19;

FIG. 21 is a waveform diagram of the first embodiment showing the result of scrambling process for the voice signal waveform shown in FIG. 19 and FIG. 20 with the circuit arrangement shown in FIG. 1;

FIG. 22 is a diagram of the first embodiment showing the spectrograph of the waveform of FIG. 21;

FIG. 23 is a waveform diagram of the first embodiment showing the result of descrambling process for the scrambled voice signal shown in FIG. 21 and FIG. 22 with the circuit arrangement shown in FIG. 2;

FIG. 24 is a diagram of the first embodiment showing the spectrograph of the descrambled signal shown in FIG. 23;

FIG. 25 is a waveform diagram of the first embodiment showing the result of clipping and cutting-off the scrambled signal shown in FIG. 21;

FIG. 26 is a diagram of the first embodiment showing the spectrograph of the clipped and cut-off signal shown in FIG. 25;

FIG. 27 is a waveform diagram of the first embodiment showing the result of descrambling process for the clipped and cut-off signal shown in FIG. 25 and FIG. 26;

FIG. 28 is a diagram of the first embodiment showing the spectrograph of the signal of FIG. 27;

FIG. 29 is a waveform diagram of the first embodiment showing a voice signal waveform of male person sampled at a sampling frequency of 6 kHz;

FIG. 30 is a diagram of the first embodiment showing the spectrograph of the voice signal of FIG. 29;

FIG. 31 is a waveform diagram of the first embodiment showing the result of scrambling process for the voice signal shown in FIG. 29 and FIG. 30 with the circuit arrangement shown in FIG. 1;

FIG. 32 is a diagram of the first embodiment showing the spectrograph of the scrambled signal of FIG. 31;

FIG. 33 is a waveform diagram of the first embodiment showing the result of frequency up-shift by 50 Hz for the scrambled signal shown in FIG. 31 and FIG. 32 and the subsequent descrambling process for the frequency-shifted signal with the circuit arrangement shown in FIG. 2;

FIG. 34 is a diagram of the first embodiment showing the spectrograph of the signal of FIG. 33;

FIG. 35 is a spectral graph of the first embodiment showing an example of the spectrum of scrambled signal;

FIG. 36 is a spectral graph of the first embodiment showing the result of SSB (Single Side Band) modulation and transmission of the scrambled signal shown in FIG. 35 and the subsequent reception and demodulation of the SSB signal, of the case of a 50-Hz difference between the modulation carrier frequency and the demodulation carrier frequency;

FIG. 37 is a block diagram showing the arrangement of the scrambling circuit based on a second embodiment of this invention;

FIG. 38 is a diagram showing the details of the scrambling circuit of FIG. 37 in the form of a signal flow graph;

FIG. 39 is a block diagram showing the arrangement of the descrambling circuit based on the second embodiment which is used in pairs with the scrambling circuit shown in FIG. 37;

FIG. 40 is a diagram showing in the form of signal flow diagram the details of the descrambling circuit shown in FIG. 39;

FIG. 41 is a waveform diagram of the second embodiment showing a voice signal of male person which is sampled at a sampling frequency of 6 kHz;

FIG. 42 is a diagram of the second embodiment showing the spectrograph of the voice signal of FIG. 41;

FIG. 43 is a waveform diagram of the second embodiment showing the result of scrambling process for the voice signal shown in FIG. 41 and FIG. 42 with the circuit arrangement shown in FIG. 37;

FIG. 44 is a diagram of the second embodiment showing the spectrograph of the scrambled signal of FIG. 43;

FIG. 45 is a waveform diagram of the second embodiment showing the result of descrambling process for the scrambled signal shown in FIG. 43 and FIG. 44 thereby to restore the original waveform with the circuit arrangement shown in FIG. 39

FIG. 46 is a diagram of the second embodiment showing the spectrograph of the descrambled signal of FIG. 45;

FIG. 47 is a block diagram showing the arrangement of the scrambling circuit based on a third embodiment of this invention;

FIG. 48 is a diagram showing in the form of signal flow diagram the details of the scrambling circuit shown in FIG. 47;

FIG. 49 is a block diagram showing the arrangement of the descrambling circuit based on the third embodiment which is used in pairs with the scrambling circuit shown in FIG. 47;

FIG. 50 is a diagram showing in the form of signal flow diagram of the details of the descrambling circuit shown in FIG. 49;

FIG. 51 is a block diagram showing an example of application of the scrambling circuit and descrambling circuit based on the first embodiment to a full-duplex communication channel;

FIG. 52 is a block diagram showing an example of application of the scrambling circuit and descrambling circuit based on the first embodiment to a half-duplex communication channel;

FIG. 53 is a block diagram showing another example of application of the scrambling circuit and descrambling circuit based on the first embodiment to a half-duplex communication channel;

FIG. 54 is a waveform diagram showing a sweep signal h[n] which is generated in accordance with formula (23) with the setup of parameters k=1, p=0.5 and q=0.002;

FIG. 55 is a waveform diagram showing the result of linear convolution of the signal h[n] of FIG. 54 and the time-reverse version thereof;

FIG. 56 is an amplitude spectral graph showing the result of discrete Fourier transform for the signal shown in FIG. 55;

FIG. 57 is a waveform diagram showing a sweep signal h which is generated in accordance with formula (24) with the setup of parameter L=300;

FIG. 58 is a waveform diagram showing the result of linear convolution of the signal h of FIG. 57 and the time-reverse version thereof; and

FIG. 59 is an amplitude spectral graph showing the result of Fourier transform for the signal shown in FIG. 58.

### DESCRIPTION OF THE PREFERRED EMBODIMENTS

First Embodiment

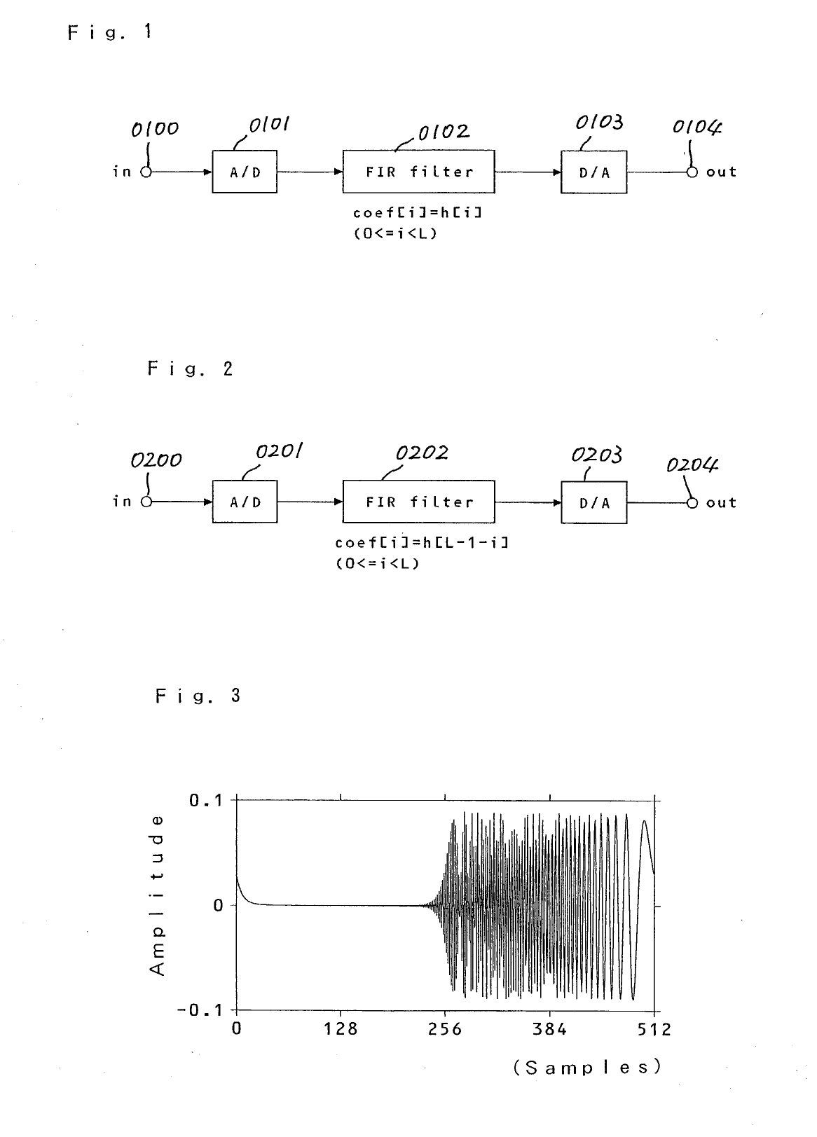

FIG. 1 shows by block diagram the analog signal scrambling circuit based on the first embodiment of this invention. The scrambling circuit includes a signal input terminal 0100 which introduces an analog signal such as a voice signal, an A/D converter 0101 which converts the analog signal on the signal input terminal 0100 into a digital signal, a first digital FIR filter (will be termed simply “FIR filter”) 0102 which implements the scrambling for the digitized voice signal, a D/A converter 0103 which converts the digital output signal of the first FIR filter 0102 into an analog signal, and a signal output terminal 0104 which releases the scrambled analog voice signal.

For the analog signal scrambling process to take place in the scrambling circuit arranged as explained above, the A/D converter 0101 converts the input analog signal into digital data, and the first FIR filter 0102 having filter factor coef[i] introduces a sweep signal h[i] which has been generated in accordance with the following formulas (1) and (2).

$$\begin{matrix}H [ n ] = \{ \begin{matrix}exp ( j \frac{2 π}{L} \frac{1}{α} {n}^{2} ) = cos ( \frac{2 π}{L} \frac{1}{α} {n}^{2} ) + j sin ( \frac{2 π}{L} \frac{1}{α} {n}^{2} ) & ( 0 \leq n \leq L / 2 ) \\ {H}^{*} [ L - n ] = cos ( \frac{2 π}{L} \frac{1}{α} {( L - n )}^{2} ) - j sin ( \frac{2 π}{L} \frac{1}{α} ( L - {n}^{2} ) ) & ( L / 2 < n < L )\end{matrix} \\ L : period * : complex conjugate {j}^{2} = - 1 & Equation ( 1 ) \\ H [ n ] = \{ \begin{matrix}cos β {n}^{2} + j sin β {n}^{2} & ( 0 \leq n \leq L / 2 ) \\ cos β {( L - n )}^{2} + j sin {β ( L - n )}^{2} & ( L / 2 < n < L )\end{matrix} \\ β = \frac{2 π}{L} \frac{1}{α} L : period {j}^{2} = - 1 \\ h [ k ] = real ( IDFT ( H [ n ] ) ) = real ( \frac{1}{L} {\sum }_{n = 0}^{L - 1} H [ n ] exp ( j \frac{2 π}{L} kn ) ) ( 0 \leq k < L ) & Equation ( {1}^{′} )\end{matrix}$$

IDFT: inverse discrete Fourier transform

real(x): real part of x

L: period

j²=−1 Equation (2)

Next, the D/A converter 0103 implements the D/A conversion for the output of the first FIR filter 0102 thereby to produce a scrambled analog signal. This process is to produce a scrambled signal y[i] based on the linear convolution of the A/D converted signal x[i] and the sweep signal h[i] as shown by the following formula (3).

$$y [ i ] = h [ i ] * x [ i ] = {\sum }_{n = 0}^{L - 1} h [ k ] x [ i - k ] \qquad Equation ( 3 )$$

where operator symbol * represents the linear convolution.

FIG. 2 shows by block diagram the descrambling circuit which is used for descrambling a signal which has been scrambled by the scrambling circuit of FIG. 1. The descrambling circuit includes a signal input terminal 0200 which introduces a scrambled analog voice signal, an A/D converter 0201 which converts the analog signal on the signal input terminal 0200 into a digital signal, a second digital FIR filter (will be termed simply “FIR filter”) 0202 which implements the descrambling process for the digitized voice signal, a D/A converter 0203 which converts the digital output signal of the second FIR filter 0202 into an analog signal, and a signal output terminal 0204 which releases the descrambled analog voice signal.

For the signal descrambling process to take place in the descrambling circuit arranged as explained above, the A/D converter 0201 converts the scrambled analog signal on the signal input terminal 0200 into digital data, and the second FIR filter 0202 having filter factor coef[i] introduces signal h[L−1−i] which is the time-reverse version of the signal h[i] on the time axis.

Next, the D/A converter 0203 implements the D/A conversion for the output of the second FIR filter 0202, thereby restoring by descrambling the original signal to be released from the signal output terminal 0204. This process is to produce a descrambled signal based on the linear convolution of the A/D converted scrambled signal y[i] and the signal h[L−1−i] as shown by the following formula (4).

w[i]=h[L−1−i]* y[i] Equation (4)

where operator symbol * represents the linear convolution.

The descrambling process produces a signal x[i−L+1] as shown by the following formula (6), and it is nothing but the input signal x[i] of the scrambling circuit only with the application of a delay by L−1 samples.

$$\begin{matrix}w [ i ] = h [ L - 1 - i ] * y [ i ] = h [ L - 1 - i ] * ( h [ i ] * x [ i ] ) \\ = ( h ( L - 1 - i ] * h [ i ] ) * x [ i ] \\ = δ [ i - L + 1 ] * x [ i ] \\ = x [ i - L + 1 ]\end{matrix} \qquad Equation ( 6 )$$

The A/D converter 0101 and D/A converter 0103 of the scrambling circuit shown in FIG. 1 and the A/D converter 0201 and D/A converter 0203 of the descrambling circuit shown in FIG. 2 must have the same sampling frequency.

Generation of the filter factor h based on formulas (1) and (2) will be explained in detail. Initially, a complex number string H is generated in accordance with formula (1), where symbol j indicates the imaginary part. Among the two parameters included in formula (1), L is the length of complex number string H and, at the same time, the length of filter factor h, and a is a constant real number excluding 0 which characterizes the generated filter factor h. The parameter α may otherwise be an arbitrary number excluding 0. The dependency of the filter factor h characteristics on the value of α will be explained later.

The complex number string H generated in accordance with formula (1) undergoes inverse discrete Fourier transform at L points, and a resulting real part gives the filter factor h. Symbol IDFT in formula (2) expresses the inverse discrete Fourier transform, and real (x) expresses the operation of taking the real part of the argument. In case the parameter a value is so set that the imaginary part of H[L/2] is zero, the symmetry of H[n] proves that the inverse discrete Fourier transform h[k] thereof is a real number string, eliminating the need of the operation real(x) for taking the real part.

The basis of attainability of signal descrambling in this manner is that the linear convolution of the signal h[i] and its time-reverse version h[L−1−i] becomes an impulse as shown by the following formula (5). Substituting formulas (3) and (4) into formula (4) results in formula (6), revealing the restoration of the original signal x[i] from y[i].

h[L−1−i]*h[i]≅δ[i−L+1] Equation (5)

Comparing the Fourier transform of the filter factor h[i] with its time-reverse versionh[L−1−i] reveals that both signals are identical in their amplitude-frequency characteristics, while having opposite phase characteristics. From this fact, it is readily understood that a system which is a tandem connection of a FIR filter having factor h[i] and a FIR filter having factor h[L−1−i] has a transfer function of a constant real number irrespective of the frequency.

The scrambling process and descrambling process based on this invention can be explained at a different view angle as follows.

Deforming and arranging formula (1) yields formula (1)′, where parameter β has a value of β=2π/Lα. Discrete Fourier transform H of h given by formula (1)′ reveals that the filter factor h is a kind of sweep signal, i.e., chirp signal, having its phase varying in proportion to the square of the frequency. In other words, h is a signal with group delays which vary in proportion to the frequency.

The time-reverse version of the factor h becomes a sweep signal, i.e., chirp signal, which is derived from the original signal h, with its frequency sweep direction being reversed. In the technical field of radarscope, a scheme of chirp radar is known. The scrambling process and descrambling process of this invention are conceived to be identical to the process of this radar scheme. According to this interpretation, the sending terminal transmits the input signal while expanding the duration of input signal energy with a phase circuit having group delays that are proportional to the frequency, and the receiving terminal compresses the received signal with a phase circuit having group delay characteristics that are opposite to those of the sending terminal thereby to restore the original signal. A major difference, however, is that the chirp radar uses a low-accuracy analog circuit to implement the expansion and compression processes for the pulse signal, whereas the inventive scrambling/descrambling scheme is based on the digital processing to implement the expansion and compression processes which are extremely accurate and theoretically distortion-free for arbitrary input signals.

That the linear convolution of the signal h[i] and its time-reverse versionh[L-1-i] becomes an impulse, which has been explained by reviewing the formulas, will be apparent from practical examples described in the following.

First, examples of sweep signal h[k] which are produced differently depending on the value of parameter a in formula (1) are shown as follows.

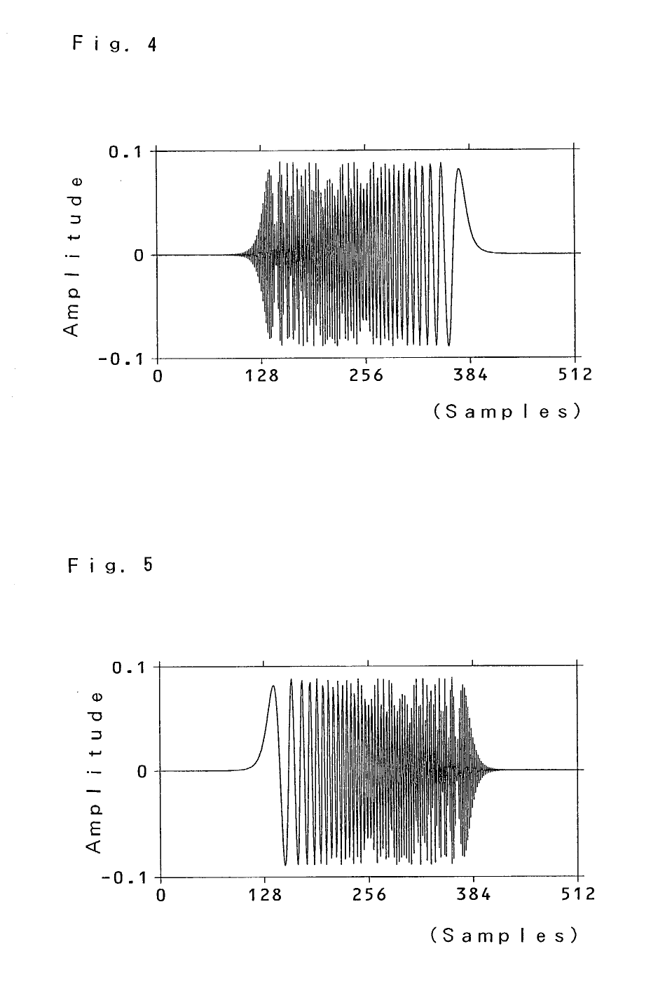

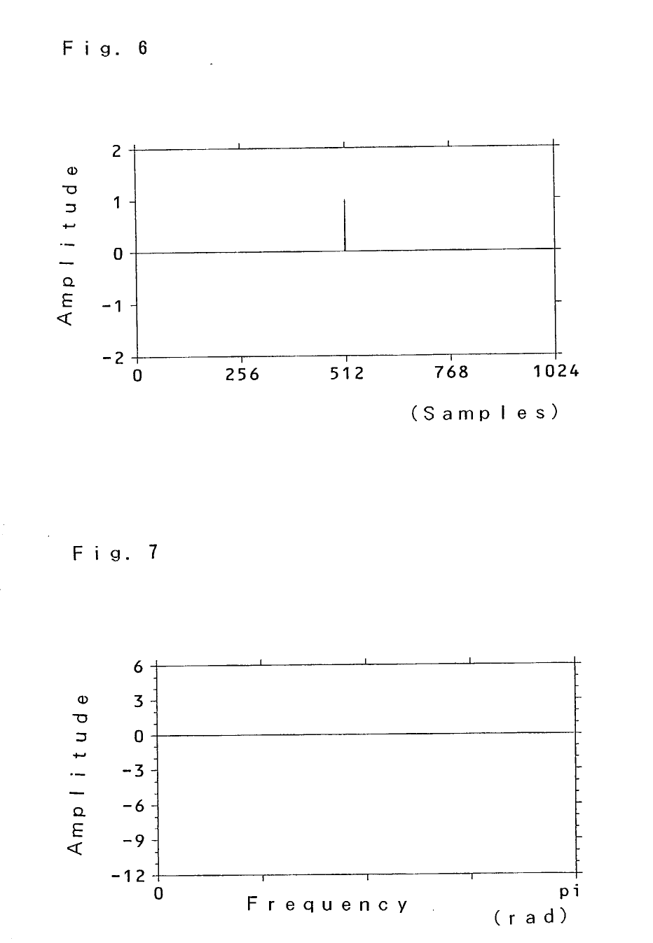

FIG. 3 shows the signal h[k] which is based on formulas (1) and (2) with the setup of α=2 and period L=512. When a is sufficiently larger than 1 in absolute value, the signal generally has a still period as shown in FIG. 3. The FIR filter 0102 used for scrambling has its factor coef[i] derived not intact from the signal h which is based on formulas (1) and (2), but from the signal h with the application of a circular shift of L/2·(1−1/α) samples to have a right-left symmetric envelope as shown in FIG. 4. For descrambling, the time-reverse version shown in FIG. 5 of the signal of FIG. 4 is used for the factor coef[i] of the FIR filter 0202.

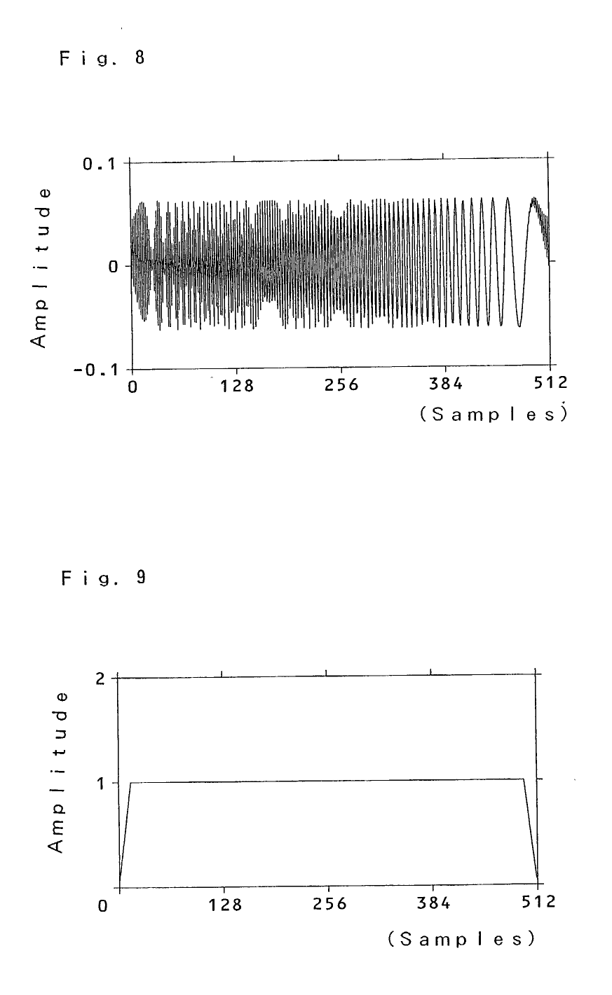

FIG. 6 shows the result of linear convolution of the signal shown in FIG. 4 and its time-reverse version shown in FIG. 5. FIG. 7 shows the amplitude spectrum resulting from the discrete Fourier transform for the result of linear convolution shown in FIG. 6. The graph has a vertical scale of dB. FIG. 6 and FIG. 7 reveal that the linear convolution of the FIR filter factor h and its time-reverse version becomes an impulse as expressed by formula (5), and the scrambling process and descrambling process using the signals shown in FIG. 4 and FIG. 5 are distortion-free.

Sweep signals of a kind having a leading or trailing still period as shown in FIG. 4 and FIG. 5 and computed in accordance with formulas (1) and (2) with the setup of a sufficiently larger than 1 in absolute value are known to be OATSP (Optimized Aoshima's Time Stretched Pulse) or simply TSP (Time Stretched Pulse) in the field of acoustic measurement. That the autocorrelation of OATSP, i.e., the linear convolution of OATSP and its time-reverse version, has a property of exact impulse is already known, and this property of OATSP is utilized for the acoustic measurement of halls. The property of linear convolution of OATSP is described in detail in the following publications.

1. TECHNICAL REPORT OF IEICE. EA 92-86 (1992 12)

THE INSTITUTE OF ELECTRONICS, INFORMATION AND COMMUNICATION ENGINEERS, DENKI ONKYO KENKYU-KAI

Title: Designing time expansion pulses

(This publication has several typographic errors.)

2. J. Acoust. Soc. Am 97(2) (1995. 2)

Acoustical Society of America

An optimum computer-generated pulse signal suitable for the measurement of very long impulse responses

Although these publications do not mention clearly, the linear convolution of the signal h generated in accordance with formulas (1) and (2) with the setup of a smaller than 1 in absolute value and the time-reverse version of the signal also becomes an impulse, which is not ideal but accurate enough to be used for the scrambling process and descrambling process. It implies that Fourier transform of the result of linear convolution creates a flat amplitude-frequency characteristics over a wide frequency range. The property of linear convolution of the signal h generated in accordance with formulas (1) and (2) with the setup of a smaller than 1 in absolute value is a new fact revealed by this patent publication.

FIG. 8 shows the signal h[k] which is based on formulas (1) and (2) with the setup of α=1 and period L=512. When a is smaller than 1 in absolute value, the signal waveform is continuous without a still period as shown. The signal h[i] may be used intact for the factor coef[i] of scrambling FIR filter 0102, or a window functionwin[i] is applied to the signal h[i] thereby to diminish the amplitude at the ends of waveform so that the descrambled signal has its error of amplitude-frequency characteristics reduced. The window function can be of a trapezoidal shape as shown by formula (7) for example.

$$win [ i ] = \{ \begin{matrix}\frac{i + 1}{P} & ( 0 \leq i < P ) \\ 1 & ( P \leq i \leq L - P ) \\ \frac{L - i}{P} & ( L - P < i < L )\end{matrix} \qquad Equation ( 7 )$$

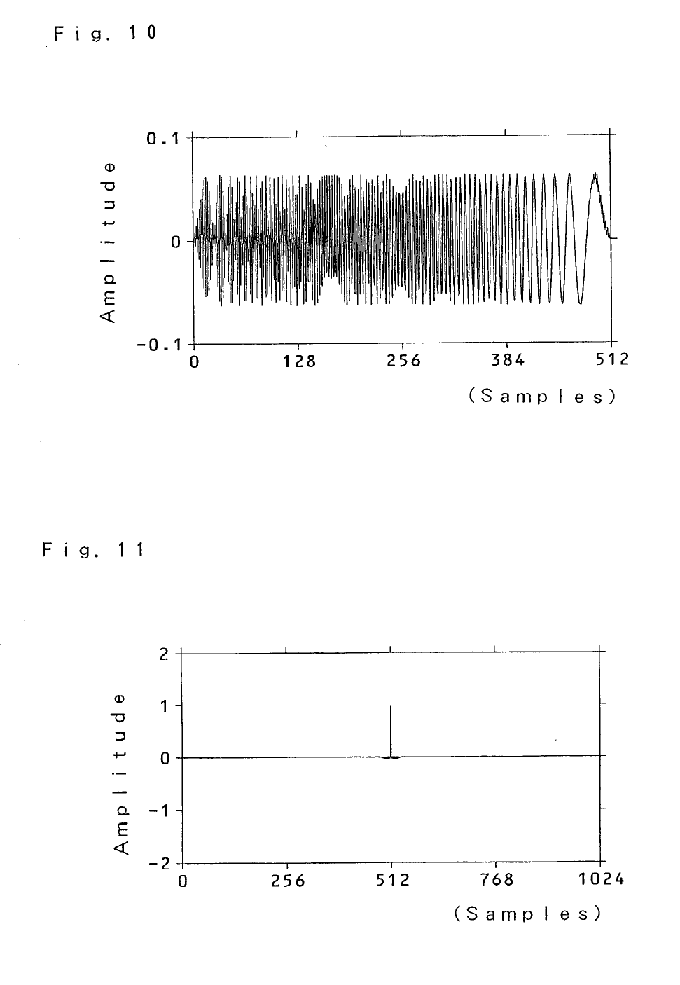

FIG. 9 shows an example of the waveform of window function win[i] which is generated in accordance with formula (7) with the setup of period L=512 and parameter P=16, and FIG. 10 shows the waveform resulting from the multiplication of the window function win[i] to the signal h[i] shown in FIG. 8.

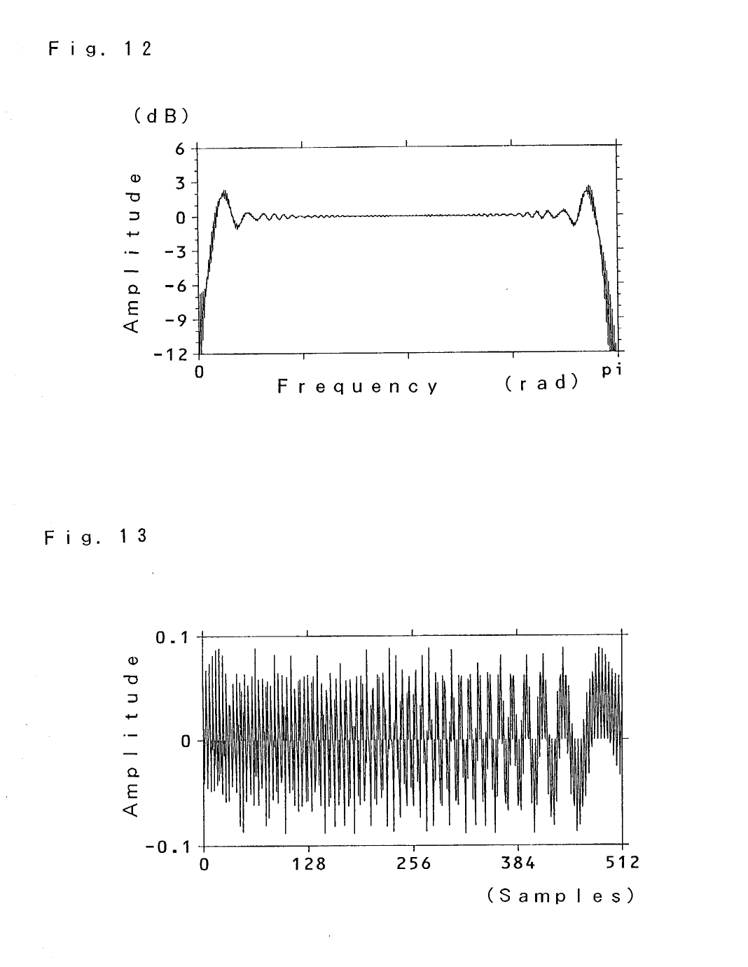

FIG. 11 shows the result of linear convolution of the signal waveform shown in FIG. 10 and its time-reverse version, and FIG. 12 shows the amplitude spectrum resulting from the discrete Fourier transform for the waveform of FIG. 11. FIG. 12 reveals that the frequency response has the property of BPF, with the components of d.c. and ½ sampling frequency being cut off, and the amplitude swelling is within ±3 dB over the frequency range of 0.05Fs-0.45Fs for sampling frequency Fs.

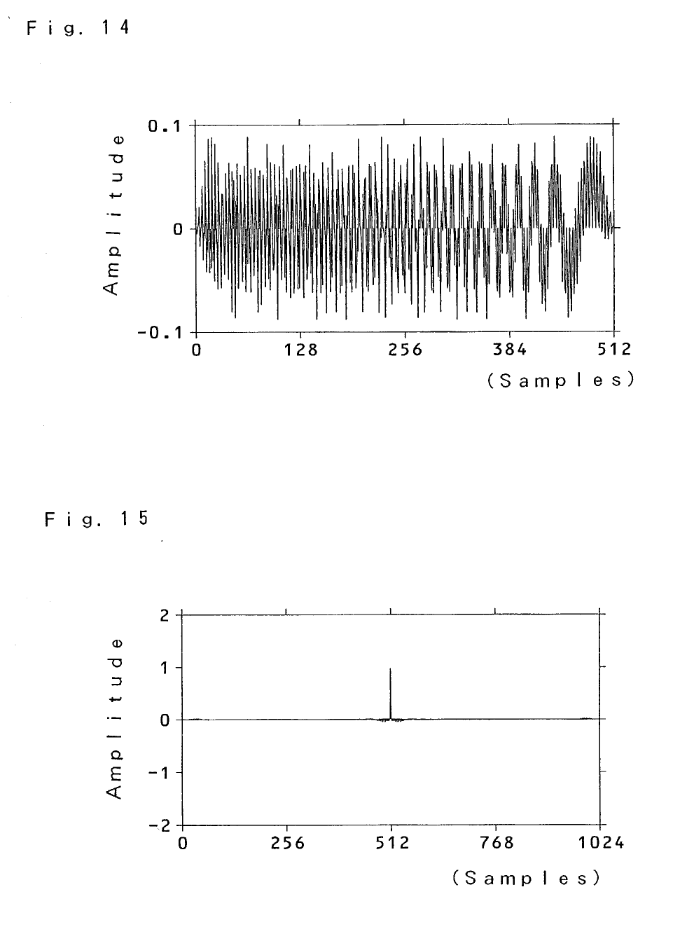

FIG. 13 shows the signal h[k] which is based on formulas (1) and (2) with the setup of α=0.5 and period L=512. FIG. 14 shows the signal resulting from the multiplication of the window function win[i], which is based on formula (7) with the setup of L=512 and P=16 and shown in FIG. 9, to the signal h[i]. The signal shown in FIG. 14 is used for the factor coef[i] of scrambling FIR filter 0102. For the descrambling of signal, the time-reverse version of the signal shown in FIG. 14 is used for the factor of FIR digital filter 0202.

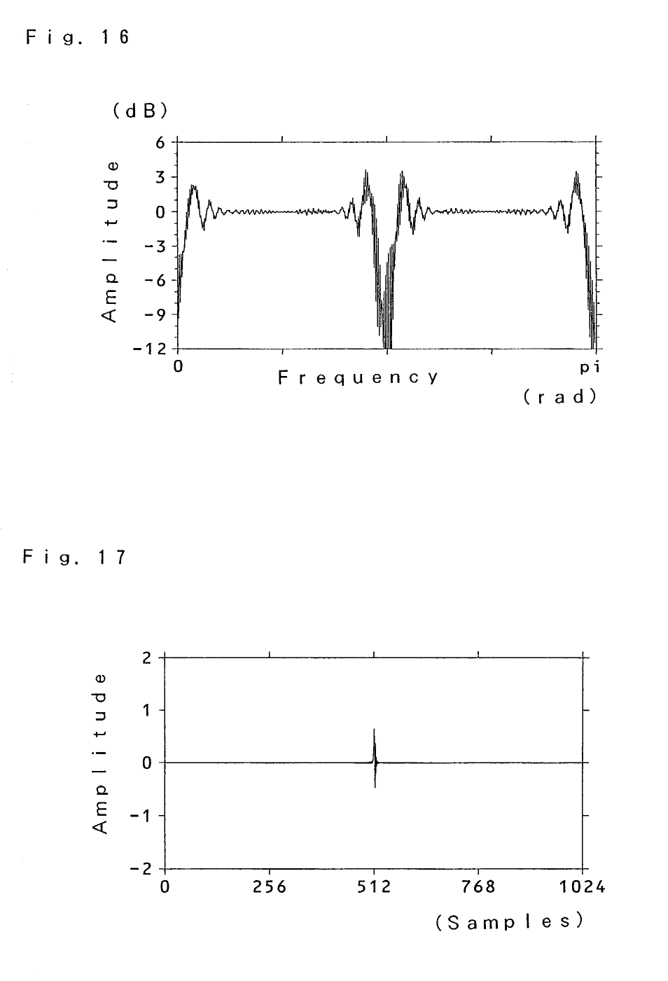

FIG. 15 shows the result of linear convolution of the signal waveform shown in FIG. 14 and its time-reverse version, and FIG. 16 shows the amplitude spectrum resulting from the discrete Fourier transform of the waveform of FIG. 15. FIG. 16 reveals that the components of d.c., ¼ sampling frequency and ½ sampling frequency are attenuated, the amplitude swelling is within ±3 dB, and no harmonic distortion arises. The attenuated ¼ sampling frequency component can readily be regained by use of an equalizer after the descrambling process.

The characteristic difference of the signal of FIG. 13 generated with the setup of α=0.5 and the signal of FIG. 8 generated with the setup of α=1 is as follows. The signal shown in FIG. 8 is a sweep signal having a frequency sweep from π to 0 in a period, whereas the signal shown in FIG. 13 is a superimposed signal of one sweep signal having a frequency sweep from π/2 to 0 in a period and another sweep signal having a frequency sweep from π to π/2 in a period. With the parameter α being further decreased in absolute value, it becomes possible to produce a signal formed of more than two sweep signals superimposed and use the resulting signal for the FIR filter factors of the scrambling circuit and descrambling circuit.

The descrambled signal differs only in amplitude-frequency characteristics from the original signal and does not create a nonlinear distortion. The parameter a of formula (1), which takes a positive value in the foregoing, can also take a negative value for generating a filter factor h useful for the scrambling process and descrambling process. The signal h generated in accordance with formulas (1) and (2) with a negative value of α is the time-reverse version of the signal generated with a positive value of α.

Conventionally, the generation scheme of a sweep signal h is defined in the time domain as shown by the following formula.

h[n]=k sin(p·n+q·n²)

where k, p and q are parameters which characterize the sweep signal. Sweep signals generated with any given parameter based on the definition in the time domain do not promise that the autocorrelation of h, i.e., the linear convolution of h and its time-reverse version, becomes an exact impulse.

In contrast, the sweep signal waveform generated based on the definition of property in the frequency domain and the inverse discrete Fourier transform according to this embodiment of invention is advantageous in getting sweep signals which autocorrelate to become exact impulses in a very wide range of parameter α. Another feature is the capability of producing an intricate sweep signal formed of multiple sweep signals as shown in FIG. 13 by varying the parameter α value. Using such an intricate sweep signal for the scrambling process can enhance the complexity of scrambling, i.e., strength of scrambling, as compared with the use of a simple sweep signal.

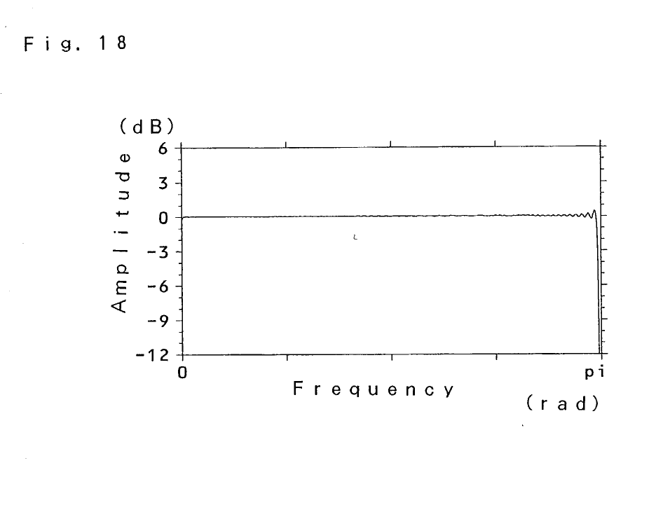

Next, the frequency characteristics of the descrambled signal resulting from the use of different sampling frequencies for the scrambling process and descrambling process will be explained. FIG. 17 shows the impulse response of the whole system resulting from the scrambling process at a sampling frequency of 10 kHz and the descrambling process at another sampling frequency of 10.1 kHz and with the FIR filter factors shown in FIG. 4 and FIG. 5, respectively.

FIG. 18 shows the amplitude-frequency characteristics of the whole system including the scrambling circuit and descrambling circuit in series resulting from the discrete Fourier transform of the impulse response shown in FIG. 17. FIG. 18 reveals that a 1% difference of sampling frequencies between the scrambling process and descrambling process merely results in an attenuation of amplitude at around ½ sampling frequency, and that the amplitude swelling is retained within ±1 dB across the frequency band. It is readily possible to keep the frequency accuracy and stability within ±0.001% based on the use of crystal oscillators for the sampling clock and operation clock generators in the scrambling circuit and descrambling circuit, enabling the accurate signal transaction without the need of clock synchronization between the scrambling circuit and descrambling circuit.

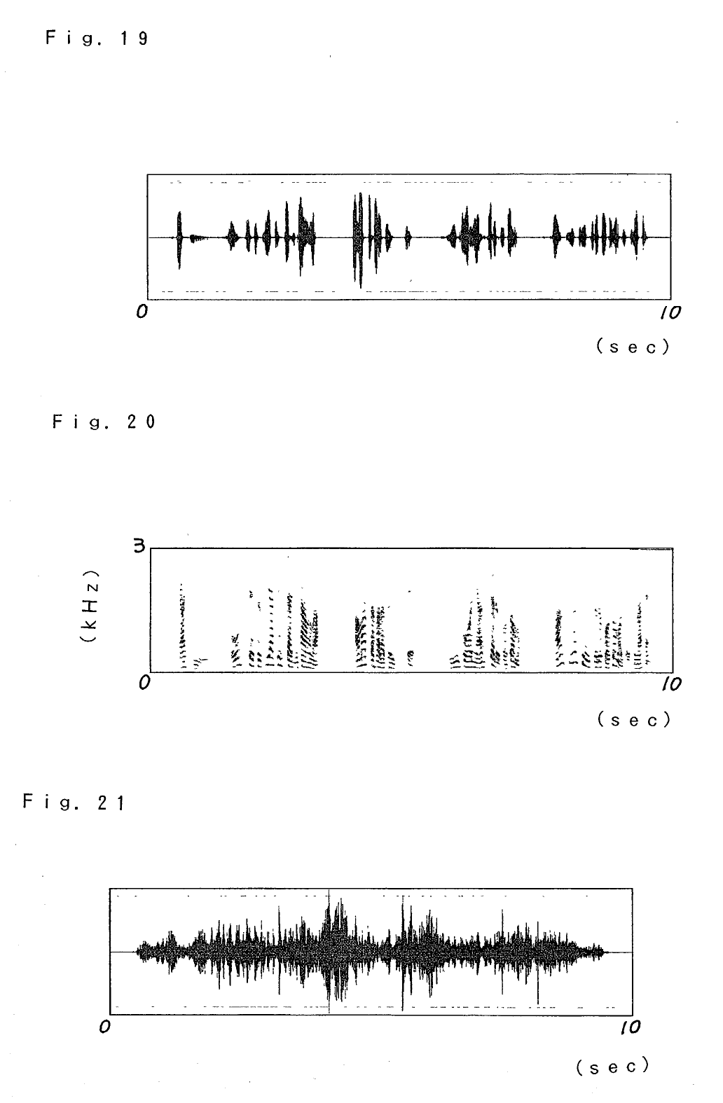

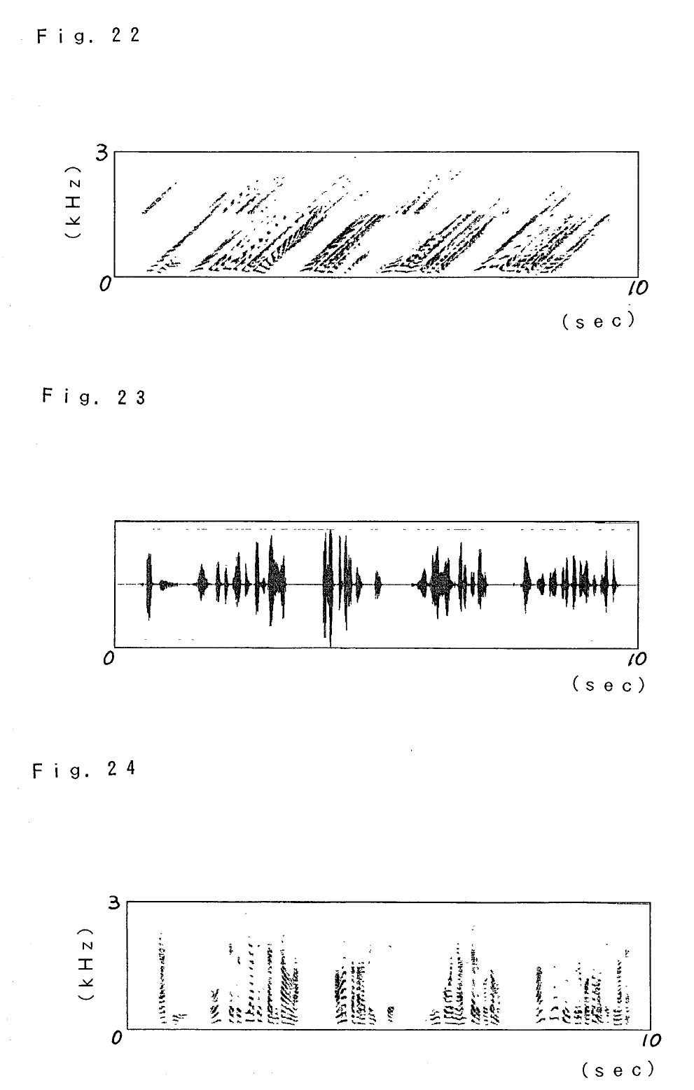

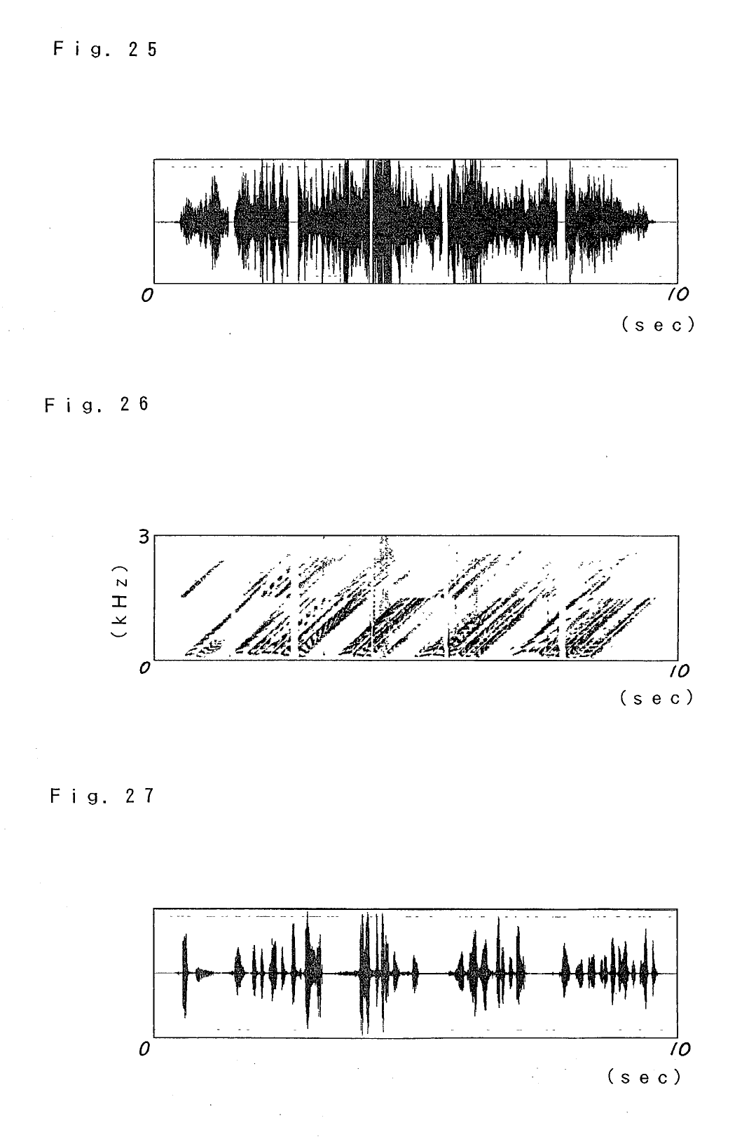

FIG. 19 through FIG. 24 show the actual processing result of a voice signal. FIG. 19 shows the waveform resulting from the A/D conversion of a voice signal of male person sampled at a sampling frequency of 6 kHz for 10 seconds, and FIG. 20 shows the spectrograph of the waveform of FIG. 19. FIG. 21 shows the waveform resulting from the scrambling process based on this invention for the signal shown in FIG. 19, and FIG. 22 shows the spectrograph of the waveform of FIG. 21. Comparing between FIG. 20 and FIG. 22 reveals a significant deformation in the spectrographic pattern of the voice signal by the scrambling process. The resulting scrambled voice signal is no more illegible to the human ear. FIG. 23 shows the waveform resulting from the descrambling process for the waveform shown in FIG. 21, and FIG. 24 shows the spectrograph of the waveform of FIG. 23. Comparing between FIG. 20 and FIG. 24 reveals that the descrambled signal has virtually no distortion.

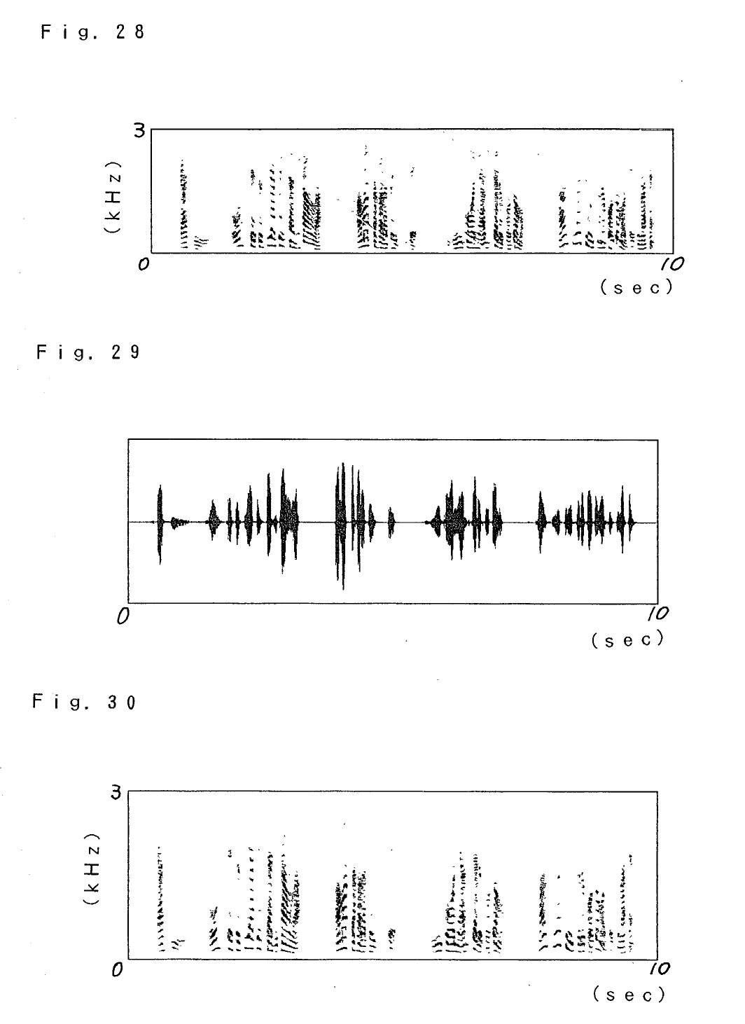

FIG. 25 through FIG. 28 show a possible result from the occurrence of momentary interruption and clipping during the radio-wave transmission of a voice signal which has been scrambled based on the inventive scrambling scheme. FIG. 25 shows the waveform of the scrambled signal which is derived from FIG. 21 and subjected to momentary interruption and clipping, and FIG. 26 shows the spectrograph of the waveform of FIG. 25. FIG. 27 shows the waveform of restored signal resulting from the descrambling of the waveform of FIG. 25, and FIG. 28 shows the spectrograph of the waveform of FIG. 27. FIG. 28 reveals that the descrambled signal has no momentary interruption, and the clipping does not create a significant harmonic distortion in the restored signal. It means that the missing of input signal energy across the entire frequency band due to the momentary interruption is converted into the missing of energy of local frequency bands which are spread in a wide range of time. The missing of partial frequency components of the input voice signal is not much adversely influential on the human's acoustic characteristics when compared with the momentary interruption of signal.

Accordingly, the inventive scrambling scheme is capable of alleviating the deterioration of acoustic legibility caused by clipping and momentary interruption of the scrambled voice signal to be transmitted, as well as enabling the stable descrambling process for the voice signal transmitted through a low-quality transmission channel which is vulnerable to momentary interruption and clipping. However, this effectiveness is attainable only in case the length of segment where the clipping and momentary interruption is arising is sufficiently shorter than the factor length of the FIR filters shown in FIG. 1 and FIG. 2, and the deterioration of acoustic legibility caused by continuous noises cannot be alleviated.

Although the scrambling circuit and descrambling circuit of this embodiment are assumed to be designed on a hardware basis, the scrambling process and descrambling process can also be accomplished on a software basis by employment of a microprocessor.

The scrambling scheme of this embodiment is equivalent in principle to the application of group delays in proportion to the frequency, i.e., delay times proportional to the frequency, to the input signal. Among the prior arts which resemble the scheme of this embodiment is described in U.S. Pat. No. 2,411,683. This U.S. patent publication describes a scrambling process which is based on the splitting of an input signal into multiple bands by using band-pass filters and the application of different delays to the bands.

A significant difference of the present invention from the technique of U.S. Pat. No. 2,411,683 is as follows. The process of this U.S. patent publication requires a number of band-pass filters and delay circuits (delay lines), and must increase the number of band-pass filters if the enhancement of the strength of scrambling is intended, resulting in a complex circuit arrangement. Whereas, the present invention uses only one FIR filter for each of the scrambling process and descrambling process, and it is advantageous in the simplicity of circuit arrangement.

Among the prior arts of scrambling process using the FIR filter, i.e., convolution process, is described in U.S. Pat. No. 5,101,432. The following describes the difference of the present invention from the technique of this U.S. patent publication.

This U.S. patent publication does not mention the detailed algorithm of the computation of filter factor, particularly the condition of ending the computation cycle of the FIR filter used for the descrambling circuit. Whereas, the present invention defines the filter factors in terms of the formula and shows by graph (FIG. 3 through FIG. 5, FIG. 8, FIG. 10, FIG. 13 and FIG. 14) several filter factors generated with a variety of parameters in the formulas (1) and (2).

The technique of U.S. Pat. No. 5,101,432 involves intricate procedures for the generation of filter factor inclusive of the cyclic process as mentioned above. The number of times of cycle and the condition of ending the cycle are not explained clearly. It describes the computation of filter factor for a filter length of 2048 and repetition of 300 times at a probability of improper result lower than 5%, i.e., at a probability of proper result of 95% or higher, however, it does not describe clearly the criterion of judging as to whether a pair of filter factors of the scrambling circuit and descrambling circuit generated based on the algorithm of repetition is proper. Whereas, according to the present invention, the descrambling circuit can have its FIR filter factor obtained simply in terms of the time-reverse version of the FIR filter factor of the scrambling circuit, instead of the need of intricate repetitive computations.

The scheme of U.S. Pat. No. 5,101,432 cannot be applied to cases where the spectrum of scrambled signal has a frequency shift. For example, in the shortwave radio communication based on the SSB (Single Side Band) modulation, the sending station and receiving station can have different carrier frequencies, which results in the occurrence of frequency shift in the spectrum of the transmission signal. In this case, this U.S. patent technique cannot implement the normal descrambling process and cannot restore the original signal. The reason for this impropriety is the use of FIR filters which vary in amplitude and phase at random against the frequency between the scrambling process and descrambling process. Whereas, the present invention uses FIR filters which have flat amplitude-frequency characteristics and vary linearly in group delays, i.e., delay times, against the frequency, enabling the normal descrambling process for a voice signal even at the emergence of frequency shift of around ±50-100 Hz in the RF circuit between the scrambling circuit and descrambling circuit. The restored voice signal which has undergone the frequency shift by ±50-100 Hz in the RF circuit does not affect significantly on the acoustic legibility. The following explains by taking practical examples the applicability of the present invention to the shortwave radio communication based on the SSB (Single Side Band) modulation.

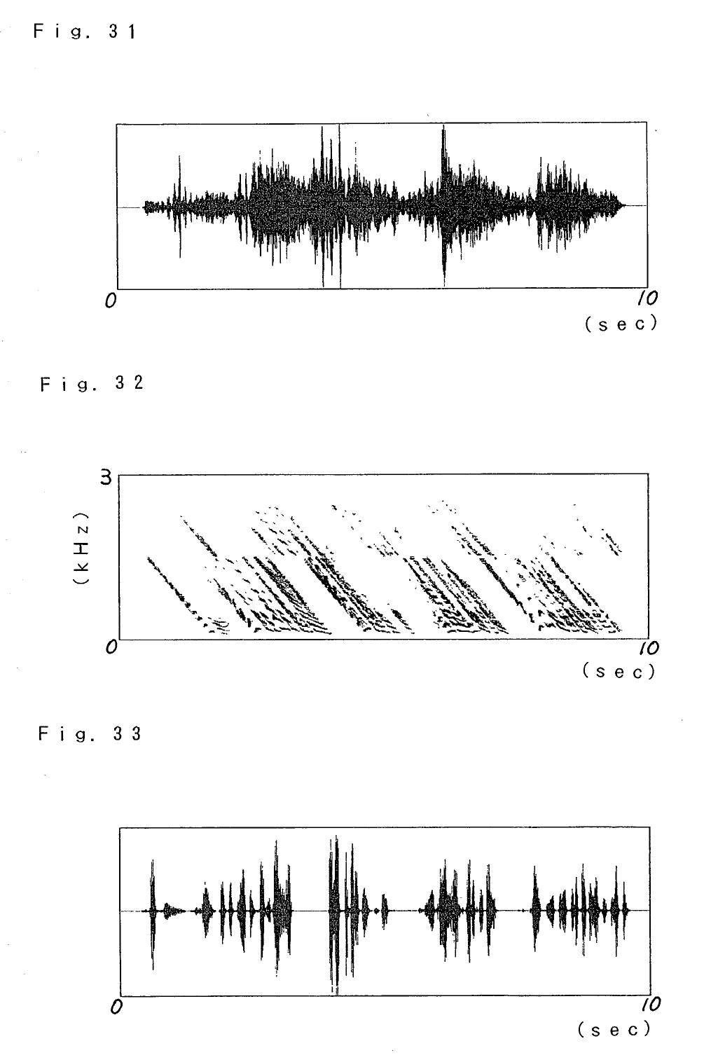

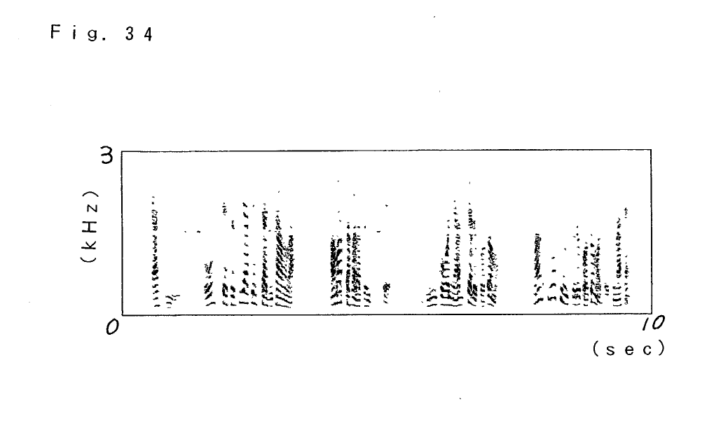

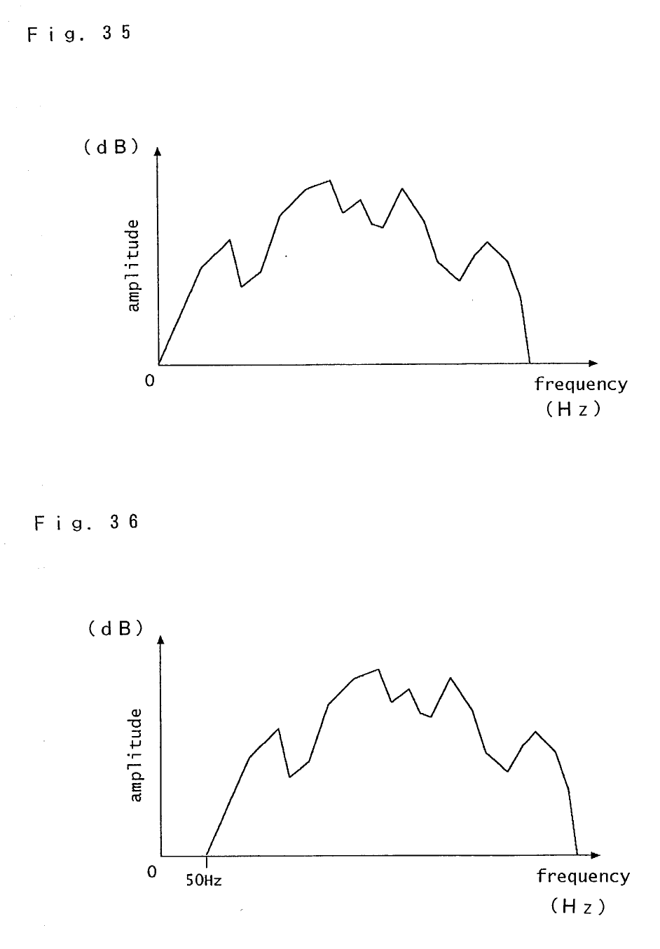

FIG. 29 shows a voice signal waveform of male person sampled at a sampling frequency of 6 kHz, and FIG. 30 shows the spectrograph of the waveform of FIG. 29. FIG. 31 shows the waveform resulting from the scrambling of the voice signal shown in FIG. 29 and FIG. 30 by the circuit of FIG. 1. The FIR filter 0102 has its filter factor obtained based on formulas (1) and (2) with the setup of parameters α=0.5, L=8192 and P=200. FIG. 32 shows the spectrograph of the scrambled signal shown in FIG. 31.

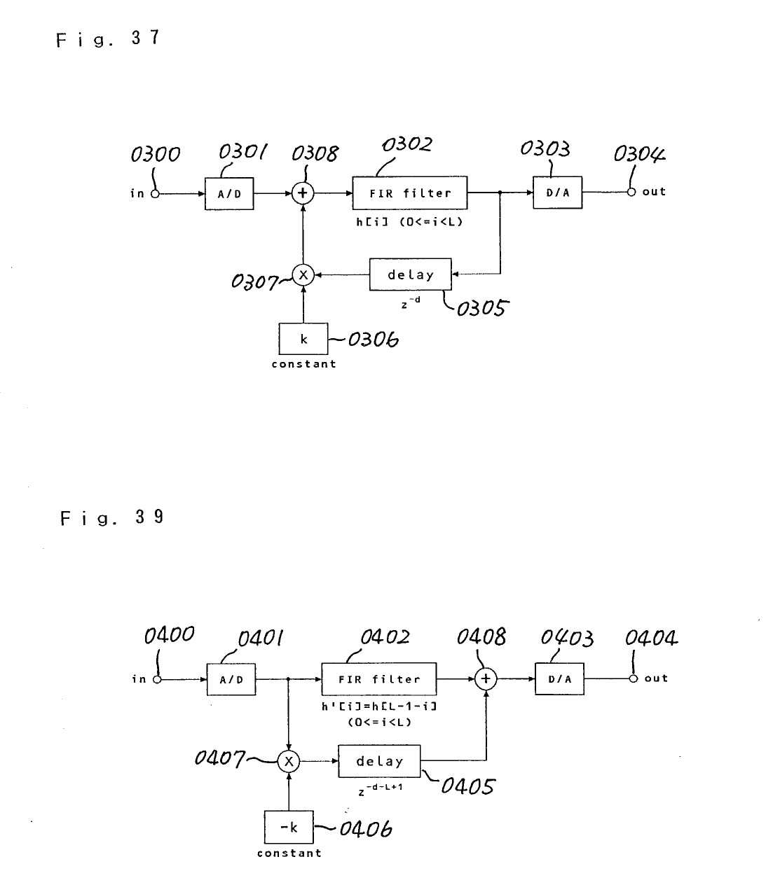

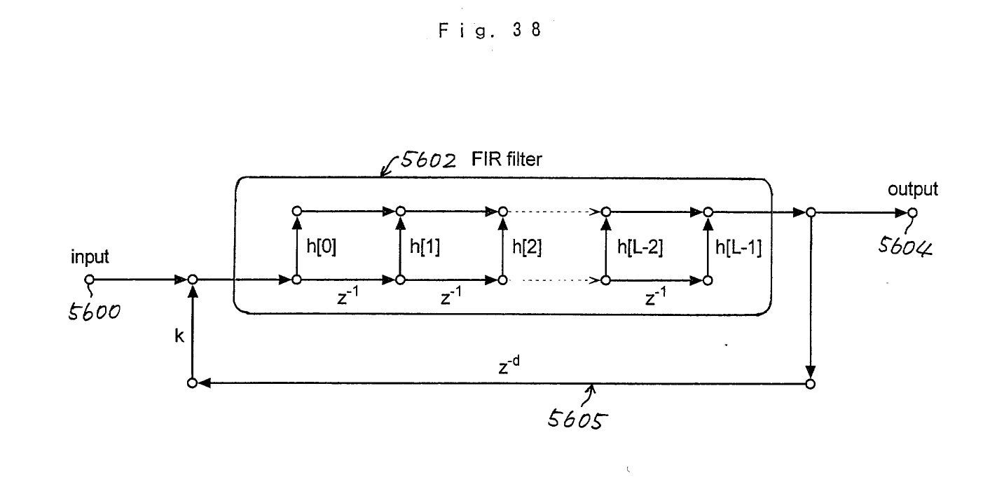

The following deals with the case of the occurrence of frequency shift at the transmission of the signal shown in FIG. 31 and FIG. 32. Specifically, the scrambled signal having a spectrum of FIG. 35 undergoes the frequency up-shift by 50 Hz in the RF circuit as shown in FIG. 36. Frequency up-shift on the spectrum as shown in FIG. 35 and FIG. 36, as well as frequency down-shift, arises in the SSB shortwave radio communication when the sending station and receiving station do not operate at an exactly equal carrier frequency. FIG. 33 shows a signal waveform resulting from the descrambling process by the circuit shown in FIG. 2 for the scrambled signal shown in FIG. 31 and FIG. 32 after it has undergone the frequency up-shift by 50 Hz on the spectrum.

FIG. 34 shows the spectrograph of the signal of FIG. 33. FIG. 33 and FIG. 34 reveal that the descrambling process takes place normally even in the presence of a frequency shift in the RF circuit and the distortion created in the descrambled signal is extremely small. As described above, the signal processing scheme based on this invention is capable of performing the descrambling process normally even in the presence of a frequency shift of around +50-100 Hz in the RF circuit in the case of dealing with voice signals. In contrast, the scheme of U.S. Pat. No. 5,101,432 cannot perform the descrambling process normally in the presence of such a frequency shift, and it cannot be applied to the radio-wave communication equipment based on the SSB modulation which is widely used in the shortwave radio communication.

The features of the foregoing first embodiment is summarized as follows.

(1) The distortion-free process does not create a harmonic distortion and modulation distortion in principle.

(2) It does not necessitate a sync signal for the scrambling process and descrambling process, and thus does not need to send a sync signal with the scrambled signal.

(3) This scrambling process does not expand the spectrum, i.e., frequency band, of the input signal.

(4) These scrambling process and descrambling process take place normally even in the presence of a difference of sampling frequencies of about 1%.

(5) This descrambling process takes place normally even at the occurrence of clipping or momentary interruption of the scrambled signal, allowing the application to the scrambling process of the shortwave radio communication which relies on low-quality transmission links.

(6) It alleviates the deterioration of communication quality caused by pulsative noises and momentary signal interruption, allowing the suitable application to the shortwave radio communication which relies on low-quality transmission links. This scrambling circuit can be used in combination with a magnetic audio recorder to alleviate the drop-out, i.e., momentary interruption, of the reproduced voice signal caused by dust stuck on the tape or the like. The circuit can also be used to alleviate the burst error caused by pulsative noises and momentary signal interruption of a data transmission terminal.

(7) This scrambling process is effective for the improvement of average modulation depth as revealed by the comparison between the input signal waveform of FIG. 19 and the scrambled signal waveform of FIG. 21.

(8) It is also applicable to signals of OFDM (Orthogonal Frequency Division Multiplexing) modulation, besides the amplitude modulation (AM) signal and SSB (Single Side Band) modulation signal. The scrambling process can improve the average modulation depth of the OFDM-modulated signal, relaxing the demand of linearity imposed on the transmitter and repeater amplifiers. The receiver is allowed to implement the usual OFDM demodulation following the descrambling process of this embodiment.

(9) It can be used for scrambling multi-dimensional signals such as a raster-scanned video signal, besides the one-dimensional voice signal.

(10) A plurality of this scrambling circuit can be connected in series, with the value of a in formula (1) for generating the filter factor h being set separately for each circuit, and a resulting increased number of key codes further enhance the strength of scrambling. Alternate connection of scrambling circuits of this embodiment and conventional scrambling circuits based on the frequency reversion scheme can also enhance the strength of scrambling.

(11) It can be applied to the scrambling of arbitrary analog signals including the modem modulation signal and FAX modulation signal, besides the voice signal.

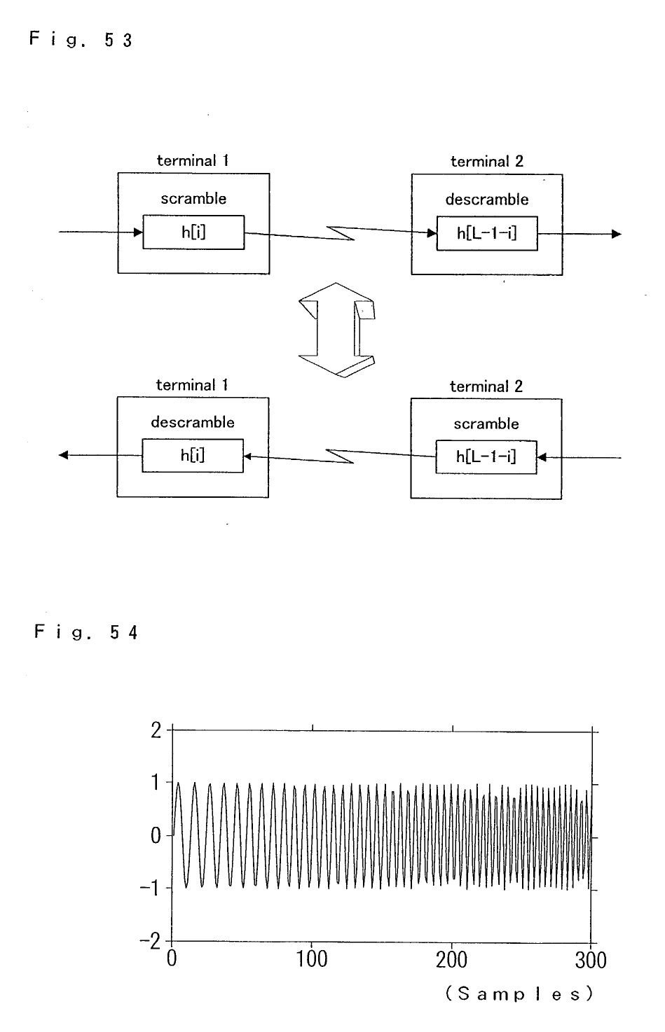

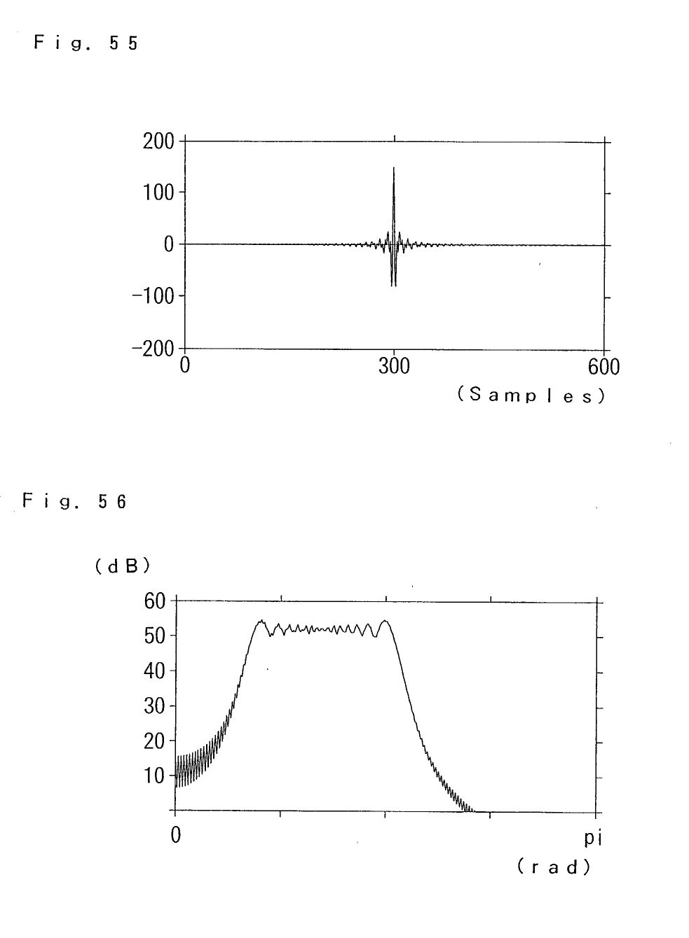

(12) The scrambling circuit and descrambling circuit of this embodiment are identical in arrangement except for their filter factors, and these circuits can share a circuit in the case of the half-duplex communication as explained in FIG. 51 through FIG. 53. FIG. 51 shows a full-duplex communication channel in which each terminal necessitates a set of scrambling circuit and descrambling circuit, FIG. 52 shows a half-duplex communication channel in which each terminal can share a circuit for scrambling and descrambling, with the FIR filter factor being switched for sending and receiving, and FIG. 53 shows another half-duplex communication channel in which each terminal can share a circuit for scrambling and descrambling without the need of switching of filter factor for sending and receiving.

The scrambling scheme of this embodiment is distortion-free in principle, and due to the absence of additional clock signal or sync signal superimposed, it can be combined with other scrambling scheme properly without intervention. For example, the scrambling scheme of this embodiment is combined with the conventional scheme made up of the A/D conversion of the analog voice signal, the data compression based on the ADPCM (Adaptive Delta Pulas Code Modulation), the scrambling process based on the exclusive logical sum with a binary pseudo random number string such as M series signals, and the QPSK (Quadrature Phase Shift Keying) modulation, and consequently the strength of scrambling can be enhanced significantly.

It is not difficult to demodulate the simply QPSK-modulated signal which is used currently for the digital radio of police service. Specifically, when the voice signal is silent, the pseudo random number string used for scrambling appears intact in the QPSK-demodulated signal. By reading part of the pseudo random number string out of the QPSK-demodulated silent data, it is possible to find out the initial value by the computer-based analysis and whole search of data. Once the initial value is found, the pseudo random number string of the entire period is known, and the QPSK-modulated signal can be descrambled.

However, in case the QPSK-modulated data further undergoes the inventive scrambling process, it becomes impossible to carry out the QPSK demodulation. It is not possible to read out the pseudo random number string used by the conventional scrambling scheme by the sampling of a silent voice signal and QPSK demodulation, and consequently the strength of scrambling can be enhanced significantly.

Instead of scrambling the QPSK-demodulated signal based on the scheme of this embodiment, an alternative manner is to scramble the input voice signal based on this embodiment first and thereafter further scramble the resulting signal based on the conventional scheme, and the strength of scrambling can be enhanced also. The inventive scrambling scheme may be used for both of the input voice signal and the QPSK-demodulated signal. The scrambling scheme of this embodiment can also be combined properly with the conventional analog scrambling schemes such as the frequency reversion scheme and frequency band split/swap scheme, besides the foregoing digital scrambling scheme.

Second Embodiment

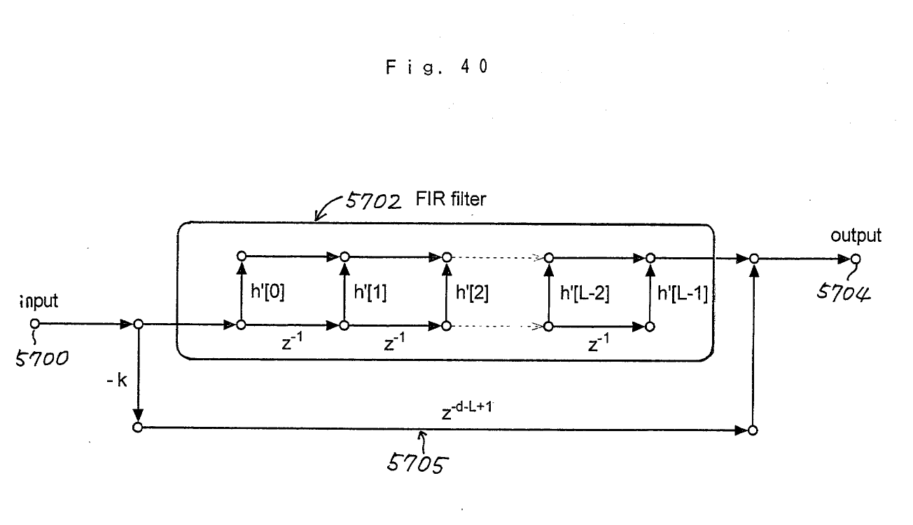

FIG. 37 shows by block diagram the analog signal scrambling circuit based on the second embodiment of this invention. The scrambling circuit includes a signal input terminal 0300 which introduces an analog signal such as a voice signal, an A/D converter 0301 which converts the analog signal on the signal input terminal 0300 into a digital signal, a third digital FIR filter (will be termed simply “FIR filter”) 0302 which implements the scrambling process for the digitized voice signal, a D/A converter 0303 which converts the digital output signal of the third FIR filter 0302 into an analog signal, and a signal output terminal 0304 which releases the scrambled analog voice signal.

The scrambling circuit of this embodiment further includes a delay line (will be called “delay means”) 0305 which delays the output signal of the third FIR filter 0302 by d samples, a constant number generation means 0306 which generates a constant number (k) for the output of the delay means 0305, a multiplier 0307 which multiplies the output of the constant number generation means 0306 to the output of the delay means 0305, and an adder 0308 which adds the output of the multiplier 0307 to the output of the A/D converter 0301. With a feedback circuit being formed in this arrangement, the output of the third FIR filter 0302 undergoes a certain delay process and multiplication process, and merges into the input of the third FIR filter 0302.

FIG. 38 shows in the form of signal flow graph the structure of the scrambling circuit of FIG. 37. The A/D converter 0301 and D/A converter 0303 are omitted in the figure. Indicated by 5600 is the input of scrambling circuit, 5602 is the FIR filter circuit (tap length: L), 5604 is the output of scrambling circuit, and 5605 is the d-sample delay line.

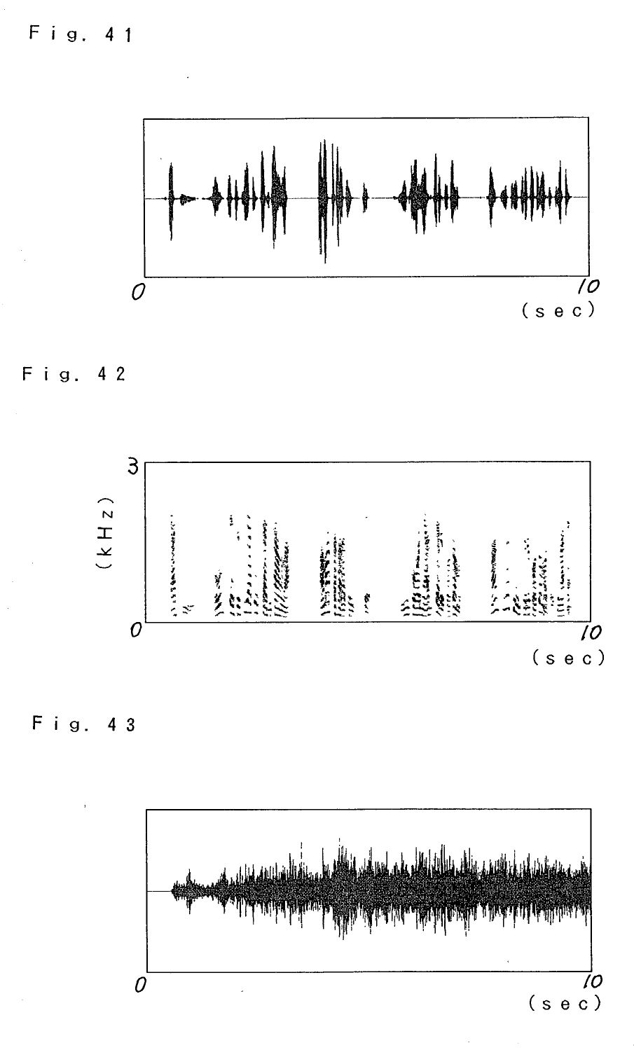

FIG. 39 shows by block diagram the descrambling circuit which is used in pairs with the scrambling circuit shown in FIG. 37. The descrambling circuit includes an input terminal 0400 which introduces a scrambled analog voice signal, an A/D converter 0401 which converts the analog signal on the signal input terminal 0400 into a digital signal, a fourth digital FIR filter (will be termed simply “FIR filter”) 0402 which implements the descrambling process for the digitized voice signal, a D/A converter 0403 which converts the digital output signal of the fourth FIR filter 0402 into an analog signal, and a signal output terminal 0404 which releases the descrambled analog voice signal.

The descrambling circuit of this embodiment further includes a delay line (will be called “delay means”) 0405 which delays the output signal of the A/D converter 0401 by d+L-1 samples, a constant number generation means 0406 which generates a constant number (-k) for the output of the A/D converter 0401, a multiplier 0407 which multiplies the output of the constant generation means 0406 to the output of the A/D converter 0401 and releases the result to the delay means 0405, and an adder 0408 which adds the output of the delay means 0405 to the fourth FIR filter 0402. With a branch circuit being formed in this arrangement, the output of A/D converter 0401, which is put to the fourth FIR filter 0402, is also put to the delay means 0405, with the output of the constant number generation means 0406 being multiplied thereto by the multiplier 0407, and the output of the delay means 0405 is merged into the output of the fourth FIR filter 0402.

FIG. 40 shows in the form of signal flow graph the structure of the descrambling circuit shown in FIG. 39. The A/D converter 0401 and D/A converter 0403 are omitted in the figure. Indicated by 5700 is the input of descrambling circuit, 5702 is the FIR filter circuit (tap length: L), 5604 is the output of descrambling circuit, and 5705 is the (d+L-1)-sample delay line. The FIR filter circuit 5702 of the descrambling circuit and the FIR filter circuit 5602 of the scrambling circuit of FIG. 38 have their filter factors h′ and h related as shown by the following formula.

h′[i]=h[L=1−i]

where L is the tap length of the FIR filter circuit 5602.

The third FIR filter 0302 in FIG. 37 has its factor h[i] generated in accordance with formulas (1) and (2). The fourth FIR filter 0402 in FIG. 39 has its factor h′[i] derived from the time-reverse version of h[i]. For the scrambling circuit of FIG. 37 having a delay of d samples and a filter factor length of L, the descrambling circuit of FIG. 39 is designed to have a delay of delay means 0405 set tobed+L−1 samples. The constant number k released by the constant number generation means 0306 of FIG. 37 is a real number which is non-zero and other than 1 in absolute value. The constant number −k released by the constant number generation means 0406 in FIG. 39 is the sign-inverted version of the output of the constant number generation means 0306 in FIG. 37.

For the scrambling circuit of FIG. 37 having signal x[n] after A/D conversion and signal y[n] before D/A conversion, these signals x[n] and y[n] relate as shown by the following formula (8).

y[n]={x[n]+k·y[n−d]}*h[n] Equation (8)

where operator symbol * represents the linear convolution.

Formula (8) undergoes the z transformation to become the following formula (12), in which X(z), Y(z) and H(z) represent the z transformation of x[n], y[n] and h[n], respectively.

x[n] [symbol] X(z) Equation (9)

y[n] [symbol] Y(z) Equation (10)

h[n] [symbol] H(z) Equation (11)

$$\begin{matrix}Y ( z ) = \{ X ( z ) + k \cdot Y ( z ) \cdot {z}^{d} \} H ( z ) \\ = X ( z ) H ( z ) + k \cdot {z}^{- d} \cdot Y ( z ) H ( z )\end{matrix} \qquad Equation ( 12 )$$

For the descrambling circuit of FIG. 39 having signal y[n] after A/D conversion and signal w[n] before D/A conversion, these signals y[n] and w[n] relate as shown by the following formula (13), where h′[n] is the time-reverse version of h[n] as shown by the following formula (14).

Formula (13) undergoes the z transformation to become the following formula (16), in which W(n) represents the z transformation of w[n] and H′(n) represents the z transformation of h′[n] as shown by the following formula (15).

w[n]=y[n]*h′[n]−k·y[n−d−L+1] Equation (13)

h′[n]=h{L−1−i] Equation (14)

h′[n] [symbol] H′(z) Equation (15)

W(z)=Y(z)H′(z)−k·z^{-d-L+}1·Y(z) Equation (16)

Substituting formula (12) into formula (16) and arranging the result results in the following formula (18), in which H(z)H′(z) has a delay of z^{-L+1}, i.e., L−1 samples in the time domain as shown by the following formula (17).

Formula (18) undergoes the inverse z transformation to become the following formula (19), in which the output w[n] of the descrambling circuit of FIG. 39 is derived from the input x[n] of the scrambling circuit with the application of a delay of L−1 samples, revealing the descrambling process of distortion-free in principle.

h[n]*h′[n]≅δ[n−L+1 [symbol] ]H(z)H′(z)=z^{-L+1} Equation (17)

$$\begin{matrix}W ( z ) = \{ X ( z ) H ( z ) + k \cdot {z}^{- d} \cdot Y ( z ) H ( z ) \} {H}^{′} ( z ) - k \cdot {z}^{- d - L + 1} \cdot Y ( z ) \\ = X ( z ) H ( z ) {H}^{′} ( z ) + k \cdot {z}^{- d} \cdot Y ( z ) H ( z ) {H}^{′} ( z ) - k \cdot {z}^{- d - L + 1} \cdot Y ( z ) \\ = X ( z ) \cdot {z}^{- L + 1} + k \cdot {z}^{- d} \cdot Y ( z ) \cdot {z}^{- L + 1} - k \cdot {z}^{- d - L + 1} \cdot Y ( z ) \\ = {z}^{- L + 1} \cdot X ( z )\end{matrix} \qquad Equation ( 18 )$$

w[n]=x[n−L+1] Equation (19)

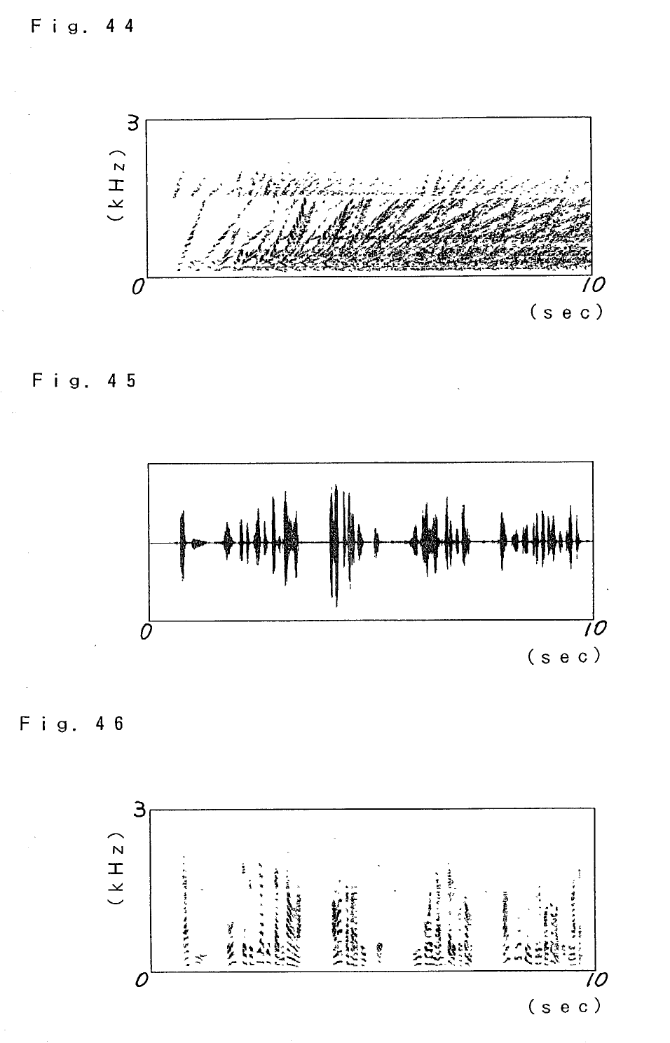

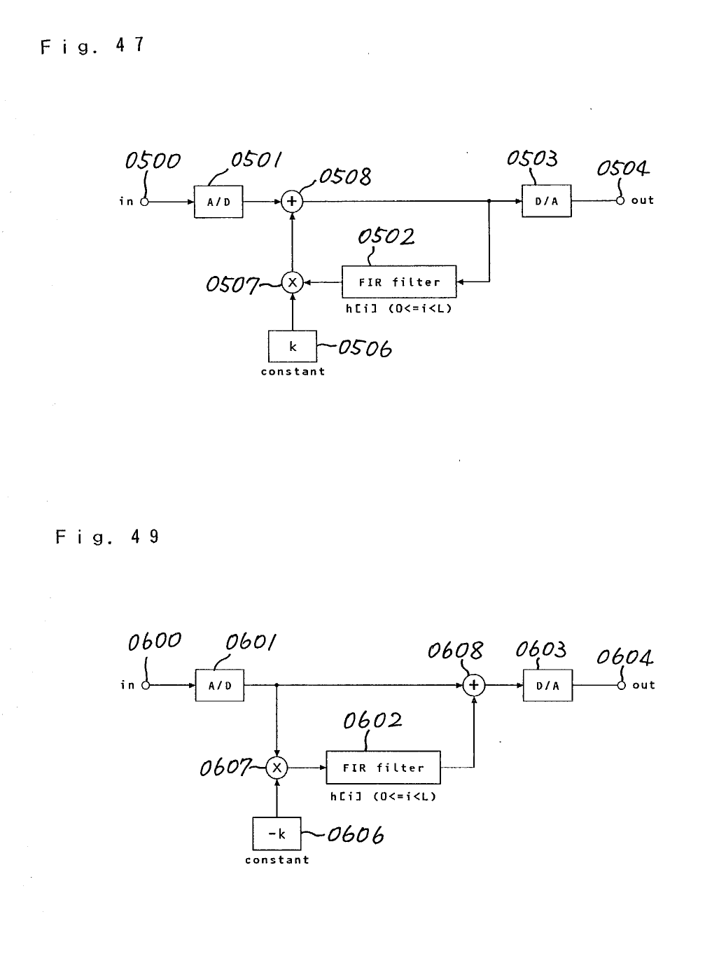

FIG. 41 through FIG. 46 show the actual processing result of a voice signal. FIG. 41 shows the waveform of a voice signal of male person sampled at a sampling frequency of 6 kHz. FIG. 42 shows the spectrograph of the waveform of FIG. 41. FIG. 43 shows the waveform resulting from the scrambling process for the signal shown in FIG. 41 and FIG. 42 by the circuit shown in FIG. 37. The FIR filter 0302 has its factor h derived from the number string generated in accordance with formulas (1) and (2) with the setup of L=4000 and α=−0.5 and multiplied to the window function generated in accordance with formula (7) with the setup of L=4000 and P=100. The delay circuit 0305 has a delay value of d=2000 samples and the constant number generation means 0306 has an output of k=0.85.

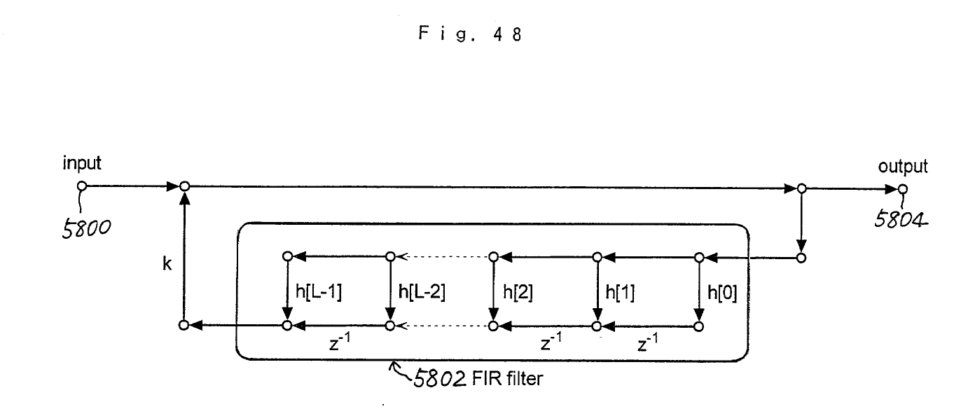

FIG. 44 shows the spectrograph of the scrambled signal of FIG. 43. The scrambled signal is completely different in waveform from the original signal. FIG. 45 shows the output signal of the descrambling circuit of FIG. 39 for the input signal shown in FIG. 43 and FIG. 44. The fourth FIR filter 0402 in FIG. 39 has its factor h′ derived from the time-reverse version of the factor h of the third FIR filter 0302 of the scrambling circuit of FIG. 37. The delay circuit 0405 is set to have a delay value of d+L−1=2000+4000−1=5999, and the constant number generation means 0406 is set to have an output number of −k=−0.85.

FIG. 46 shows the spectrograph of the descrambled signal. FIG. 45 and FIG. 46 reveal the restoration of original signal in virtually distortion-free.

By connecting scrambling circuits and connecting descrambling circuits based on this embodiment each in multiple stages, with the parameters being set separately for each stage, the strength of scrambling can be enhanced. The strength of scrambling can also be enhanced by connecting scrambling circuits of this embodiment and conventional scrambling circuits of the frequency reversion scheme alternately in multiple stages. The circuit of FIG. 37 and the circuit of FIG. 39 may be used for descrambling and scrambling, respectively, in a manner of swapping. In this case, however, the impulse response of scrambling circuit does not have the IIR characteristics which last infinitely, but has IIR characteristics of finite impulse response, resulting in a degraded acoustic scrambling strength.

Among the prior arts which resemble the scheme of this embodiment is described in Japanese Patent Publication No.7941/1995. The invention of this patent publication uses a feedback circuit, i.e., a simple reverberation circuit, for scrambling and uses for descrambling an FIR filter circuit which is opposite in transfer characteristics to the scrambling circuit. As compared with this prior art, this embodiment implements the scrambling process which is more intricate than the combination of the FIR filter circuit which varies in group delays in proportion to the frequency and the feedback circuit having the IIR characteristics, and therefore it achieves the higher effectiveness of speech secrecy in terms of the acoustics. The scheme of this embodiment is capable of varying the factor of FIR filter circuit in addition to parameters including the delay of delay circuit and the output of constant number generation circuit, and accordingly it is superior over the prior art of Japanese Patent Publication No.7941/1995 due to its larger number of code keys which correspond to the number of patterns of processing.

Although the scrambling circuit and descrambling circuit of the second embodiment are assumed to be designed on a hardware basis, the scrambling process and descrambling process can also be accomplished on a software basis by employment of a microprocessor. The second embodiment has abundant features identical to those of the first embodiment.

Third Embodiment

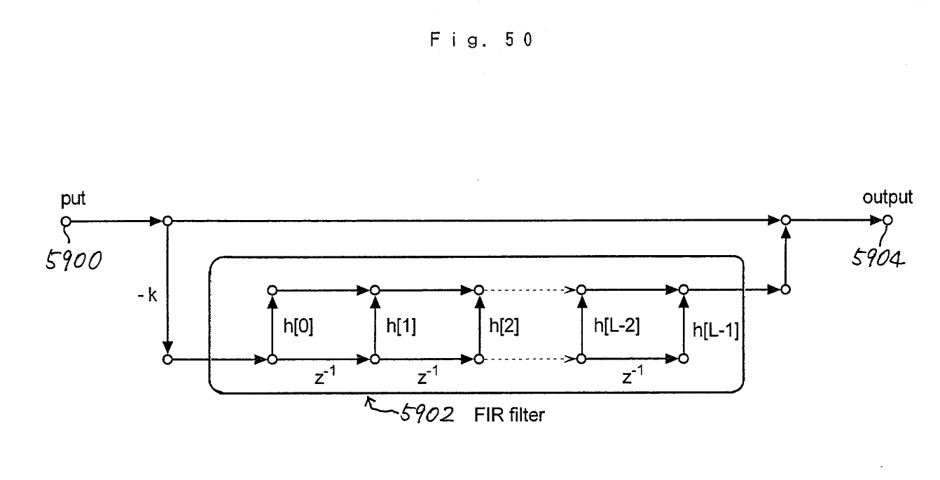

FIG. 47 shows by block diagram the analog signal scrambling circuit based on the third embodiment of this invention. The scrambling circuit includes a signal input terminal 0500 which introduces an analog signal such as a voice signal, an A/D converter 0501 which converts the analog signal on the signal input terminal 0500 into a digital signal, a fifth digital FIR filter (will be termed simply “FIR filter”) 0502 which implements the scrambling process for the digitized voice signal, a D/A converter 0503 which converts the digital output signal of the fifth FIR filter 0502 into an analog signal, and a signal output terminal 0504 which releases the scrambled analog voice signal.

The fifth FIR filter 0502 forms a feedback circuit, in which are included a constant number generation means 0506 which provides a constant number (k) for the output of the fifth FIR filter 0502, a multiplier 0507 which multiplies the output of the constant number generation means 0506 to the output of the FIR filter 0502, and an adder 0508 which adds the outputs of the multiplier 0507 to the output of the A/D converter 0501. The adder 0508 has its output D/A undergoing the D/A conversion by the D/A converter 0503, and the resulting scrambled signal is released from the output terminal 0504. With a feedback circuit being formed in this arrangement, the output of the fifth FIR filter 0502 undergoes a certain multiplication process, and thereafter merges into the output of the A/D converter 0501.

FIG. 48 shows in the form of signal flow graph the structure of the scrambling circuit of FIG. 48. The A/D converter 0501 and D/A converter 0503 are omitted in the figure. Indicated by 5800 is the input of scrambling circuit, 5802 is the FIR filter circuit (tap length: L), and 5804 is the output of scrambling circuit.

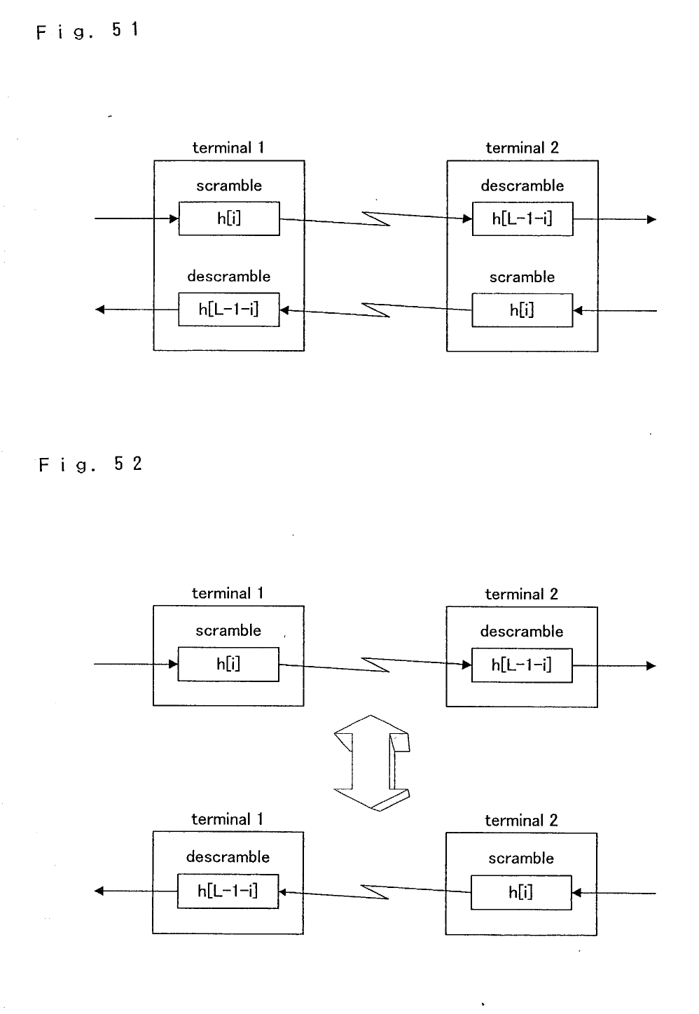

FIG. 49 shows by block diagram the descrambling circuit which is used in pairs with the scrambling circuit shown in FIG. 47. The descrambling circuit includes an input terminal 0600 which introduces a scrambled analog voice signal, an A/D converter 0601 which converts the analog signal on the signal input terminal 0600 into a digital signal, a sixth digital FIR filter (will be termed simply “FIR filter”) 0602 which implements the descrambling process for the digitized voice signal, a D/A converter 0603 which converts the digital output signal of the A/D converter 0601 into an analog signal, and a signal output terminal 0604 which releases the descrambled analog voice signal.

The descrambling circuit further includes a multiplier 0607 which multiplies the output (−k) of a constant number generation means 0606 to the output of the A/D converter 0601 and put the multiplication result to the sixth FIR filter 0602, and an adder 0608 which adds the outputs of the sixth FIR filter 0602 to the A/D converter 0601. Based on this circuit arrangement, the A/D converter 0601 has its output undergoing a certain multiplication process, with the result being put to the sixth FIR filter 0602, the output of which is merged to the output of the A/D converter 0601.

FIG. 50 shows in the form of signal flow graph the structure of the descrambling circuit of FIG. 49. The A/D converter 0601 and D/A converter 0603 are omitted in the figure. Indicated by 5900 is the input of descrambling circuit, 5902 is the FIR filter circuit (tap length: L), and 5904 is the output of descrambling circuit.

The fifth FIR filter 0502 in FIG. 47 and the sixth FIR filter 0602 in FIG. 49 use the filter factor h generated in accordance with formulas (1) and (2). Different from the first and second embodiments, the scrambling circuit and descrambling circuit of this embodiment use the same FIR filter factor.

For the scrambling circuit of FIG. 47 having signal x after A/D conversion and signal y before D/A conversion, these signals x and y relate as shown by the following formula (20).

y[i]=x[i]+k·h[i]*y[i] Equation (20)

For the descrambling circuit of FIG. 49, having signal y after A/D conversion and signal w before D/A conversion, these signals y and w relate as shown by the following formula (21).

w[i]=y[i]−k·h[i]*y[i] Equation (21)

Formula (20) is deformed as shown by the following formula (22).

y[i]−k·h[i]*y[i]=x[i] Equation (22)

Substituting formula (22) into formula (21) results in w[i]=x[i], revealing that the output of descrambling circuit is obviously the same as the input of scrambling circuit and no process delay arises. Operator symbol * in formulas (20), (21) and (22) represents the linear convolution.

This embodiment is characterized to have no process delay although the strength of scrambling is slightly lower as compared with the second embodiment, and accordingly it is suitable for applications where small process delay is required.

In this embodiment, the circuit of FIG. 47 and the circuit of FIG. 49 can be used for the descrambling process and the scrambling process, respectively, in a manner of swapping. In this case, however, the circuit of FIG. 49 has an impulse response of finite length, and therefore the strength of scrambling is lower than the case of scrambling by use of the circuit with the impulse response of infinite length.

The FIR filters 0502 and 0602 in FIG. 47 and FIG. 49 can be each replaced with a serial connection of the FIR filter 0502 or 0602 and a delay circuit (refer to FIG. 37 and FIG. 39) in implementing the scrambling and descrambling processes. In this case, by designing the delay circuit to have a large delay value, a moderate strength of scrambling can be achieved even with FIR filters of a short length, i.e., short tap length.

Although the scrambling circuit and descrambling circuit of the third embodiment are assumed to be designed on a hardware basis, the scrambling process and descrambling process can also be accomplished on a software basis by employment of a microprocessor. The third embodiment has abundant features identical to those of the first embodiment.

Although the first, second and third embodiments use filter factors h which are generated in accordance with formulas (1) and (2), it is also possible to use the conventional sweep signal which is defined in the time domain as shown by the following formula (23) for the scrambling process and descrambling process.

h[n]=k sin(p·n+q·n²) Equation (23)

Using this formula to get a filter factor does not necessitate the computation of inverse Fourier transform, enabling a significant reduction of the computation of filter factor as compared with the first, second and third embodiments. In this case, however, the widely flat amplitude-frequency characteristics of the first, second and third embodiments cannot be accomplished. The formula (23) does not promise the optimal filter factor for the scrambling process and descrambling process for arbitrary combinations of parameters, and therefore it is necessary to determine the parameters on a trial-and-error basis. Parameters k, p and q in formula (23) characterize the sweep signal.

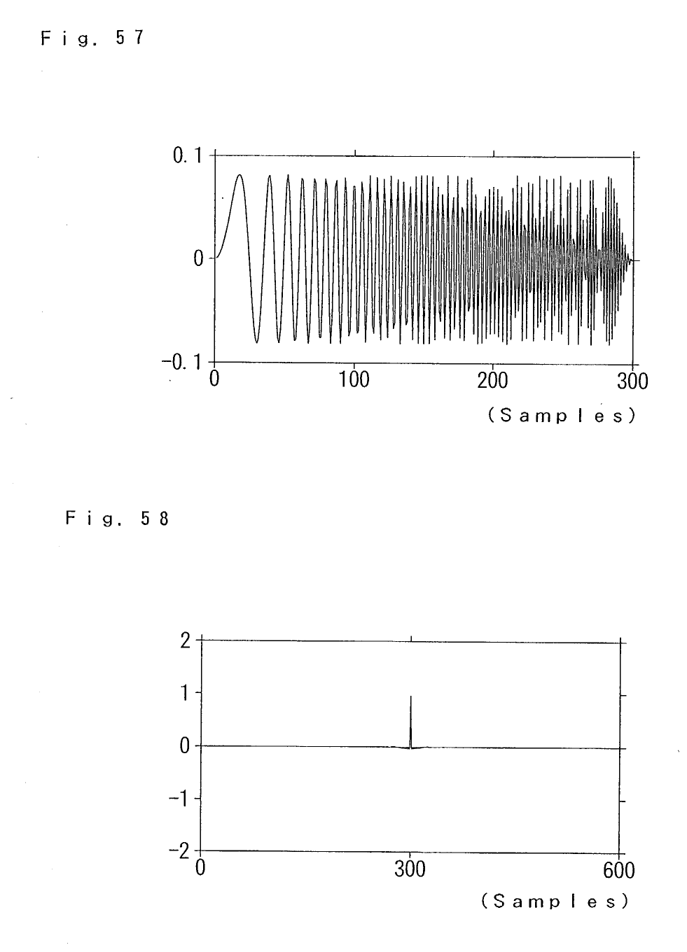

FIG. 54 shows a practical example of the filter factor h which is generated in accordance with formula (23) with the setup of parameters k=1, p=0.5 and q=0.002. The signal length L is 300 and the range of n is 0≦n<L, i.e., 0≦n<300. FIG. 55 shows the result of linear convolution of the signal h shown in FIG. 54 and the time-reverse version thereof. FIG. 56 shows the amplitude spectrum resulting from the Fourier transform of the result of linear convolution of FIG. 55, revealing that the amplitude-frequency characteristics have the property of band-pass filter. On this account, the scrambling process for a signal by use of the filter factor h generated in accordance with formula (23) causes the descrambled signal also to have the property of band-pass filter shown in FIG. 56. Accordingly, it is possible to use a filter factor h generated in accordance with formula (23) of the time domain for the scrambling process of voice signals or the like which have narrow band widths and do not require the high-quality signal transmission, although the resulting frequency characteristics will be inferior to the first, second and third embodiments.

When a sweep signal defined in the time domain is used for the filter factor of scrambling process and descrambling process, the best amplitude-frequency characteristics will be attained by the definition of sweep signal based on the following formula (24).

$$h [ n ] = \frac{1}{\sqrt{L / 2}} sin ( \frac{π}{2 L} {n}^{2} ) ( 0 \leq n < L ) \qquad Equation ( 24 )$$

where L is the filter length, i.e., FIR filter tap length.

The formula (24) is equivalent to formula (23) with the setup of parameters

$$k = \frac{1}{\sqrt{L / 2}} , p = 0 , q = \frac{π}{2 L}$$

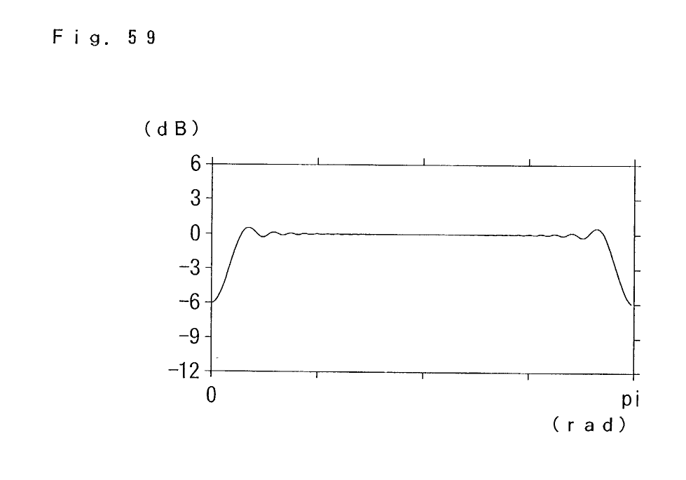

FIG. 57 shows a practical example of the FIR filter factor h which is generated in accordance with formula (24) with the setup of filter length L=300. FIG. 58 shows the result of linear convolution of the signal h shown in FIG. 57 and the time-reverse version thereof, exhibiting a beautiful impulse as compared with the previous result of FIG. 55.

FIG. 59 shows the amplitude spectrum resulting from the Fourier transform of the signal of FIG. 58, revealing that the frequency response is flat over a wide frequency range, although it ripples and the amplitude drops by about 6 dB at frequencies 0 and π. Comparing FIG. 59 with FIG. 56 reveals clearly that the better transfer characteristics can be accomplished by use of a filter factor generated in accordance with formula (23). Whereas, the use of a filter factor generated in accordance with formula (24) is advantageous in that the computation is extremely simple due to the absence of inverse discrete Fourier transform (IDFT) for getting the filter factor.

While the present invention has been described for the illustrated preferred embodiments, it will be obvious to those skilled in the art that various alterations and modifications may be made without departing from the invention. It is therefore intended to cover all such variations as fall within the scope of the present invention.

What is claimed is:

1. A method of speech secrecy in which the sending side implements a scrambling process for a signal to be sent and the receiving side implements a descrambling process for a received signal each based on the linear convolution for the signal by use of an FIR filter,
wherein one of said scrambling process and descrambling process is implemented with an FIR filter having such a filter factor h that the discrete Fourier transform thereof is:
$$DFT ( h [ n ] ) = \{ \begin{matrix}cos β {n}^{2} + j sin β {n}^{2} & ( 0 \leq n \leq L / 2 ) \\ cos {β ( L - n )}^{2} + j sin {β ( L - n )}^{2} & ( L / 2 < n < L ) \end{matrix}$$
where DFT stands for the operation of discrete Fourier transform, L is the tap length of FIR filter and, at the same time, the data length of discrete Fourier transform, n is an integer ranging from 0 to L−1, β is a parameter which takes a random number excluding 0 and characterizes said FIR filter, and j signifies the imaginary part, and
another of said scrambling process and descrambling process is implemented with an FIR filter having a filter factor that is the time-reverse version on time axis of said filter factor h.

2. A method of signal scrambling and descrambling in which a signal is treated in a scrambling process by use of an FIR filter which implements the linear convolution for the signal, a delay means, a constant number generation means which produces output k, an adder and a multiplier, and a resulting scrambled signal is treated in a descrambling process by use of an FIR filter, a delay means, a constant number generation means which produces output −k, an adder and a multiplier,
wherein the outputs k and −k of said constant number generation means are non-zero and smaller than 1 in absolute value,
one FIR filter used by one of said scrambling process and descrambling process has such a filter factor h that the discrete Fourier transform thereof is:
$$DFT ( h [ n ] ) = \{ \begin{matrix}cos β {n}^{2} + j sin β {n}^{2} & ( 0 \leq n \leq L / 2 ) \\ cos {β ( L - n )}^{2} + j sin {β ( L - n )}^{2} & ( L / 2 < n < L ) \end{matrix}$$
where DFT stands for the operation of discrete Fourier transform, L is the tap length of FIR filter and, at the same time, the data length of discrete Fourier transform, n is an integer ranging from 0 to L−1, β is a parameter which takes a real number excluding 0 and characterizes said FIR filter, and j signifies the imaginary part, and
another FIR filter used by another of said scrambling process and descrambling process has a filter factor that is the time-reverse version on time axis of the filter factor h.

3. An apparatus for signal scrambling and descrambling comprising a scrambling processor which includes a first FIR filter for implementing the linear convolution for a signal, a constant number generation means which produces output k, an adder and a multiplier, and a descrambling processor which includes a second FIR filter for implementing the linear convolution for a signal, a constant number generation means which produces output −k, an adder and a multiplier,
wherein the outputs k and −k of said constant number generation means are non-zero and smaller than 1 in absolute value,
said first FIR filter used by said scrambling processor and said second FIR filter used by said descrambling processor have such a same filter factor h that the discrete Fourier transform thereof is:
$$DFT ( h [ n ] ) = \{ \begin{matrix}cos β {n}^{2} + j sin β {n}^{2} & ( 0 \leq n \leq L / 2 ) \\ cos {β ( L - n )}^{2} + j sin {β ( L - n )}^{2} & ( L / 2 < n < L )\end{matrix}$$
where DFT stands for the operation of discrete Fourier transform, L is the tap length of FIR filter and, at the same time, the data length of discrete Fourier transform, n is an integer ranging from 0 to L−1, β is a parameter which takes a real number excluding 0 and characterizes said FIR filters, and j signifies the imaginary part.

4. A signal scrambling and descrambling apparatus according to claim 3, wherein said scrambling processor forms such a feedback circuit that the output of said first FIR filter is delayed by a delay means which is connected to the output of said first FIR filter, the output k of said constant number generation means is multiplied to the output of said delay means by said multiplier, and the output of said multiplier is added to the input signal of said scrambling processor by said adder, with the result of addition being put to said first FIR filter.

5. A signal scrambling and descrambling apparatus according to claim 3, wherein said descrambling processor forms such a branch circuit that a scrambled input signal, which is put to said second FIR filter, is also put by being branched to said constant number generation means, the output of said constant number generation means is multiplied to the input signal by said multiplier, with the multiplication result being put to a delay means, and the output of said delay means is added to the output of said second FIR filter.

6. A speech secrecy method according to claim 1, wherein said FIR filter factor h is generated in accordance with formula:
h[n]=k sin(p·n+q·n²)
where k, p and q are constant real numbers which characterize said FIR filter.

7. An analog signal scrambling method according to claim 2, wherein said FIR filter factor h is generated in accordance with formula:
h[n]=k sin(p·n+q·n²)
where k, p and q are constant real numbers which characterize said FIR filter.

8. An analog signal scrambling and descrambling apparatus according to claim 3, wherein said FIR filter factor h is generated in accordance with formula:
h[n]=k sin(p·n+q·n²)
where k, p and q are constant real numbers which characterize said FIR filter.

9. A speech secrecy method according to claim 1, wherein said FIR filter factor h is generated in accordance with formula:
$$h [ n ] = \frac{1}{\sqrt{L / 2}} sin ( \frac{π}{2 L} {n}^{2} ) ( 0 \leq n < L )$$
where L is the FIR filter tap length.

10. An analog signal scrambling method according to claim 2, wherein said FIR filter factor h is generated in accordance with formula:
$$h [ n ] = \frac{1}{\sqrt{L / 2}} sin ( \frac{π}{2 L} {n}^{2} ) ( 0 \leq n < L )$$
where L is the FIR filter tap length.

11. An analog signal scrambling and descrambling apparatus according to claim 3, wherein said FIR filter factor h is generated in accordance with formula:
$$h [ n ] = \frac{1}{\sqrt{L / 2}} sin ( \frac{π}{2 L} {n}^{2} ) ( 0 \leq n < L )$$
where L is the FIR filter tap length.

12. A signal scrambling apparatus comprising: a signal input terminal which introduces an analog signal; an A/D converter which converts the analog signal on said signal input terminal into a digital signal; an FIR filter which implements the scrambling for the digitized signal; a D/A converter which converts the scrambled digital signal into an analog signal; an output terminal which is connected to said D/A converter to release the scrambled analog signal; a delay means which delays the output signal of said FIR filter; a constant number generation means which provides a constant number for the output of said delay means; a multiplier which multiplies the output of said constant number generation means to the output of said delay means; and an adder which adds the output of said multiplier to the output of said A/D converter,
said signal scrambling apparatus forming such a feedback circuit that the output of said first FIR filter is delayed by said delay means which is connected to the output of said FIR filter, output k of said constant number generation means is multiplied to the output of said delay means by said multiplier, and the output of said multiplier is added to the input signal by said adder, with the result of addition being put to said FIR filter.

13. A signal descrambling apparatus comprising: a signal input terminal which introduces a scrambled analog signal; an A/D converter which converts the analog signal on said signal input terminal into a digital signal; an FIR filter which implements the descrambling process for the digitized signal; a D/A converter which converts the digital output signal of said FIR filter into an analog signal; a signal output terminal which releases the descrambled analog signal; a delay means which delays the output signal of said A/D converter; a constant number generation means which provides a constant number for the output of said A/D converter; a multiplier which multiplies the output of said constant number generation means to the output of said A/D converter; and an adder which adds the output of said delay means to the output of said FIR filter,
said signal descrambling apparatus forming such a branch circuit that the scrambled input signal, which is digitized by said A/D converter and put to said FIR filter, is also put by being branched to said constant number generation means, the output of said constant number generation means is multiplied to the input signal by said multiplier, with the multiplication result being put to said delay means, and the output of said delay means is added to the output of said FIR filter.
